(19) United States
(12) Patent Application Publication
(10) Pub. No.: US 2024/0098679 A1
(43) Pub. Date: Mar. 21, 2024

(54) USER DEVICE POSITIONING USING ASSISTANCE DATA

(71) Applicant: Fraunhofer-Gesellschaft zur Förderung der angewandten Forschung e.V., München (DE)

(72) Inventors: Birendra GHIMIRE, Erlangen (DE); Mohammad ALAWIEH, Erlangen (DE); Norbert FRANKE, Erlangen (DE)

(21) Appl. No.: 18/498,306

(22) Filed: Oct. 31, 2023

Related U.S. Application Data
(63) Continuation of application No. PCT/EP2022/062062, filed on May 4, 2022.

(30) Foreign Application Priority Data
May 7, 2021 (EP) 21 172 896.9

(51) Int. Cl. H04W 64/00; H04L 5/00; H04W 24/10

(52) U.S. Cl. CPC H04W 64/00; H04L 5/0048; H04W 24/10

(57) ABSTRACT

A user device, UE, of a wireless communication network is described that, for determining a position of the UE in accordance with a positioning procedure, performs positioning measurements. The UE includes an assistance data, AD, set, and the AD set includes a plurality of assistance data, AD, instances. Each AS instance is applicable for the UE to perform the positioning measurements at a certain location in the wireless communication network. The UE is to perform the positioning measurements in accordance with the assistance data, AD, instance applicable for the UE at a current location of the UE in the wireless communication network.

### CROSS-REFERENCES TO RELATED APPLICATIONS

This application is a continuation of copending International Application No. PCT/EP2022/062062, filed May 4, 2022, which is incorporated herein by reference in its entirety, and additionally claims priority from European Application No. EP 21 172 896.9, filed May 7, 2021, which is incorporated herein by reference in its entirety.

### BACKGROUND OF THE INVENTION

The present invention relates to the field of wireless communication systems or networks, more specifically to approaches for determining a position of a user device within a wireless communication network employing assistance data for assisting the user device when performing positioning measurements. Embodiments concern approaches for providing assistance data for a UE performing positioning measurements in a certain state, e.g., in a non-connected state or in a state with reduced connectivity, like the RRC_INACTIVE state or the RRC_IDLE state. The RRC_INACTIVE state or the RRC_IDLE state may be referred to as a state with reduced connectivity because since Rel. 17 the small data transmission, SDT, mechanism allows some data transfer in the RRC_INACTIVE mode in the downlink, DL.

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi communication system or a 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also have a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g. Discrete Fourier Transform-spread-OFDM, DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

In a wireless communication network, like the one depicted in FIG. 1, it may be desired to determine a position of a UE with a certain accuracy, for example, it may be desired to not only determine that a UE is within certain cell of the wireless communication network, but to actually determine the position of the UE, for example, in the form of geographical coordinates, within the network area or within a cell of such a network. Several positioning procedures are known, like satellite-based positioning procedures, for example the autonomous and assisted global navigation satellite system, A-GNSS, such as GPS, or mobile radio cellular positioning procedures, for example, Observed Time Difference Of Arrival, OTDOA, and enhanced cell ID, E-CID, or combinations thereof.

It is noted that the information in the above-section is only for enhancing the understanding of the background of the invention and, therefore, it may contain information that does not form conventional technology that is already known to a person of ordinary skill in the art.

Starting from the above, there may be a need for improvements or enhancements with regard to the determination of a position of an entity, like a user device of a wireless communication system or network.

### SUMMARY

An embodiment may have a user device, UE, of a wireless communication network, wherein, for determining a position of the UE in accordance with a positioning procedure, the UE is to perform positioning measurements, wherein the UE comprises an assistance data, AD, set, the AD set comprising a plurality of assistance data, AD, instances, each AD instance applicable for the UE to perform the positioning measurements at a certain location in the wireless communication network, wherein the UE is to perform the positioning measurements in accordance with the AD instance activated by the UE for a current location of the UE in the wireless communication network, wherein an area of the wireless communication network where an AD instance is applicable is indicated by an AD area identifier, and wherein the UE is to activate an AD instance from the AD set that comprises an AD area identifier that matches an area identifier for the current location of the UE, and wherein the area identifier identifies a certain part or sub-area of the wireless communication network.

Another embodiment may have a Location Management Function, LMF, apparatus for determining a position of a user device, UE, of a wireless communication network, which is in a non-connected state, like an RRC_INACTIVE state or an RRC_IDLE state, the apparatus comprising: a position determining processor to determine a position of the UE, responsive to receiving from the UE positioning measurements, wherein the apparatus is to provide the UE with an assistance data, AD, set, the AD set comprising a plurality of AD instances, each AD instance applicable for the UE to perform positioning measurements in the non-connected state at a certain location in the wireless communication network, thereby allowing the UE to activate, responsive to determining a current location of the UE in the wireless communication network, an AD instance from the AD set that corresponds to or is associated with the current location of the UE, wherein an area of the wireless communication network where an AD instance is applicable is indicated by an AD area identifier, and wherein the UE is to activate an AD instance from the AD set that comprises an AD area identifier that matches an area identifier for the current location of the UE, and wherein the area identifier identifies a certain part or sub-area of the wireless communication network, and wherein the apparatus is to provide the UE with the AD set during a paging occasion for the UE.

Another embodiment may have a wireless communication system, comprising one or more inventive user devices, UEs, and/or an inventive Location Management Function, LMF, apparatus.

Another embodiment may have a method for operating a user device, UE, of a wireless communication network, the method comprising: performing, by the UE, positioning measurements to be used for determining a position of the UE in accordance with a positioning procedure, wherein the UE comprises an assistance data, AD, set, the AD set comprising a plurality of assistance data, AD, instances, each AD instance applicable for the UE to perform the positioning measurements at a certain location in the wireless communication network, wherein the UE performs the positioning measurements in accordance with the AD instance activated by the UE for a current location of the UE in the wireless communication network, wherein an area of the wireless communication network where an AD instance is applicable is indicated by an AD area identifier, and wherein the UE activates an AD instance from the AD set that comprises an AD area identifier that matches an area identifier for the current location of the UE, and wherein the area identifier identifies a certain part or sub-area of the wireless communication network.

Another embodiment may have a non-transitory digital storage medium having a computer program stored thereon to perform the method for operating a user device, UE, of a wireless communication network, the method comprising: performing, by the UE, positioning measurements to be used for determining a position of the UE in accordance with a positioning procedure, wherein the UE comprises an assistance data, AD, set, the AD set comprising a plurality of assistance data, AD, instances, each AD instance applicable for the UE to perform the positioning measurements at a certain location in the wireless communication network, wherein the UE performs the positioning measurements in accordance with the AD instance activated by the UE for a current location of the UE in the wireless communication network, wherein an area of the wireless communication network where an AD instance is applicable is indicated by an AD area identifier, and wherein the UE activates an AD instance from the AD set that comprises an AD area identifier that matches an area identifier for the current location of the UE, and wherein the area identifier identifies a certain part or sub-area of the wireless communication network, when said computer program is run by a computer.

### BRIEF DESCRIPTION OF THE DRAWINGS

Embodiments of the present invention will be detailed subsequently referring to the appended drawings, in which:

FIGS. 1a and 1b are a schematic representation of an example of a terrestrial wireless network;

FIG. 2 illustrates the general positioning procedure according to TS 38.305;

FIG. 3 schematically illustrates the mobility of a UE within a wireless communication network;

FIG. 4 illustrates an example of the IE ProvideAssistanceData applicable for Rel. 16 UE positioning;

FIGS. 5(a), 5(b), and 5(c) illustrate assistance data that is applicable to UE positioning in TDOA, AoD and Multi-RTT in Rel. 16 UE positioning;

FIG. 6 illustrates the IE NR-DL-PRS-AssistanceData according to Rel. 16 TS 37.355;

FIG. 7 is a schematic representation of a wireless communication system including a transmitter, like a base station, and one or more receivers, like user devices, UEs, for implementing embodiments of the present invention;

FIG. 8 illustrates an embodiment of a structure of positioning assistance data that may be employed by a UE for performing positioning measurements during a positioning session;

FIG. 9 schematically illustrates a part of a wireless communication system including a UE in accordance with embodiments of a first aspect of the present invention;

FIG. 10 schematically illustrates a part of a wireless communication system including a UE in accordance with embodiments of a second aspect of the present invention;

FIG. 11 schematically illustrates a part of a wireless communication system including a UE in accordance with embodiments of a third aspect of the present invention;

FIG. 12 schematically illustrates a part of a wireless communication system including a UE in accordance with embodiments of a fourth aspect of the present invention;

FIG. 13 schematically illustrates an assistance data set that may be provided for a UE in accordance with embodiments of the present invention;

FIG. 14 illustrates an embodiment for validity states of assistance data and the respective transitions between the states;

FIG. 15 illustrates an embodiment for determining the DL-PRS to be measured by a UE;

FIGS. 16 and 16a illustrate a further embodiment for determining the DL-PRS to perform the positioning measurement;

FIG. 16a schematically illustrates, similar to FIG. 3, the mobility of a UE within a wireless communication network with two instances of assistance data, in accordance with embodiments, having some TRPs in common and the two assistance data differing in an order of priority in which the TRPs that are common in two assistance data instances may be measured;

FIG. 17 illustrates a call flow for a UE positioning measurement during an RRC_INACTIVE state in accordance with embodiments of the present invention

FIG. 18 illustrates an RRC_INACTIVE procedure in a cellular network in accordance with embodiments of the present invention;

FIGS. 19(a), 19(b), 19(c), 20, 21, 22, 23, and FIG. 24 illustrate additional IEs provided in accordance with embodiments of the present invention for signaling assistance data, e.g., for the TDOA, AoD and Multi-RTT of FIG. 5;

FIG. 25 illustrates the connected/non-connected states the UE may take and the transitions from one state to another state; and

FIG. 26 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

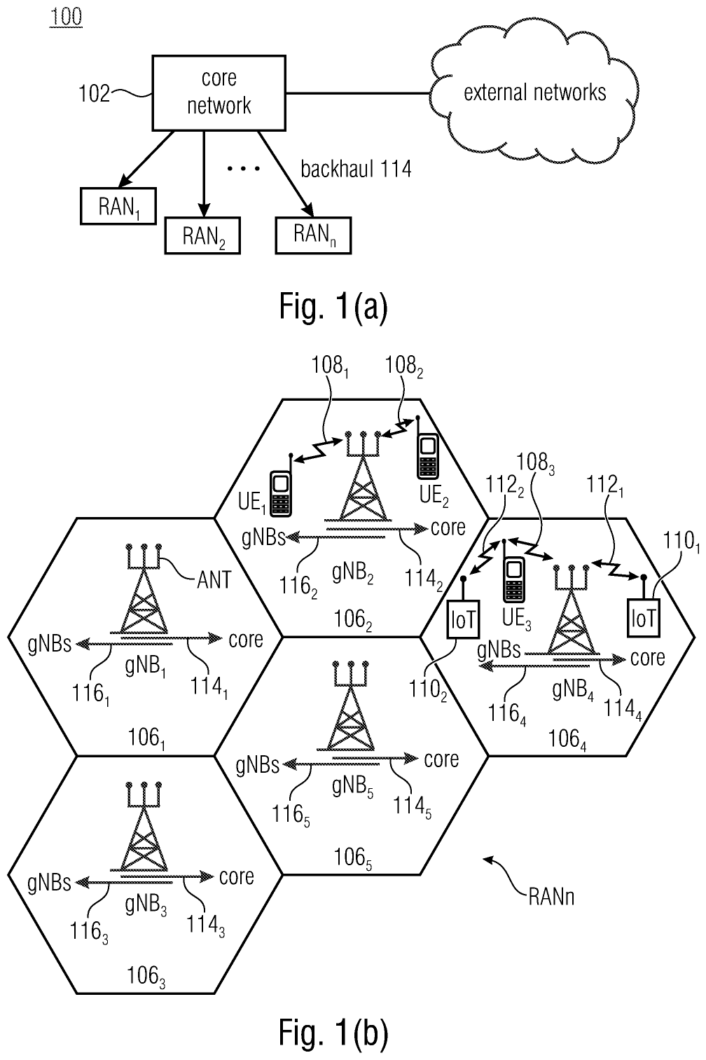

In a wireless communication network, like the depicted in FIGS. 1a and 1b, it may be desired to determine a position of a UE with a certain accuracy, for example, to not only determine that a UE is within certain cell of the wireless communication network, but to actually determine the position of the UE, for example, in the form of geographical coordinates, within the network or within a cell of such a network. Several positioning procedures are known, like satellite-based positioning procedures, for example autonomous and assisted global navigation satellite systems, A-GNSS, such as GPS, or mobile radio cellular positioning procedures, for example, observed time difference of arrival, OTDOA, and enhanced cell ID, E-CID, or combinations thereof.

It is noted that the information in the above-section is only for enhancing the understanding of the background of the invention and, therefore, it may contain information that does not form conventional technology that is already known to a person of ordinary skill in the art.

Starting from the above, there may be a need for improvements or enhancements with regard to the determination of a position of an entity, like a user device of a wireless communication system or network.

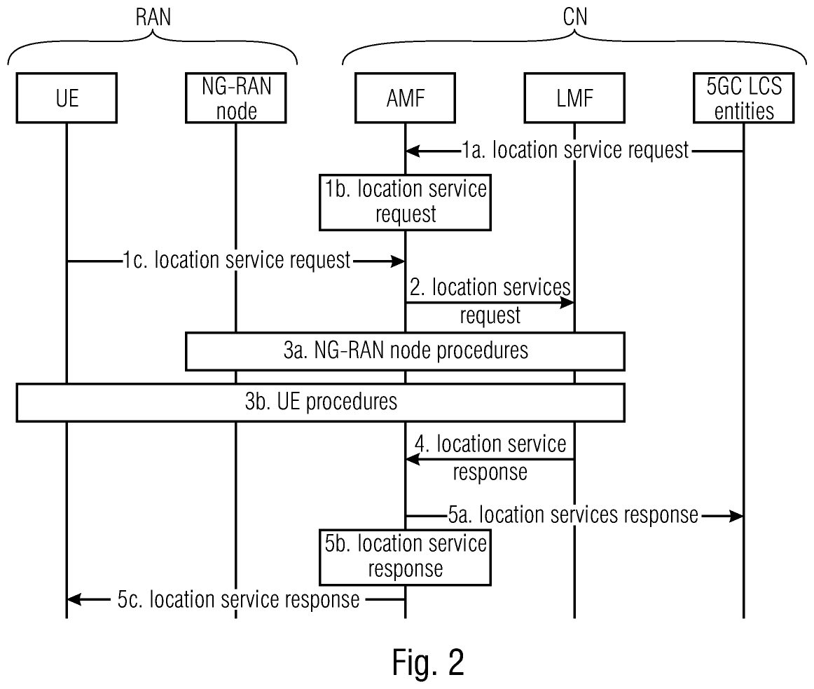

For determining a position of a network entity, like a user device or a UE, of a wireless communication network, the wireless communication network may provide or support location services, LCS, for example the location service as described in TS 38.305 Rel. 16. FIG. 2, illustrates the general positioning procedure according to TS 38.305 in accordance with which a location management function, LMF, interacts with a new generation radio access network node, NG-RAN node, and the user device, UE, for causing the NG-RAN node and/or the UE to obtain measurements required for determining the actual position of the UE, for example a position indicating geographical coordinates of the UE either with respect to a certain area or on a global basis. FIG. 2 illustrates, schematically, the radio access network, RAN, and the core network, CN, of a wireless communication system. For the RAN, the UE and the NG-RAN node, like a gNB, are illustrated. The CN includes the access and mobility function, AMF, the LMF and further entities of the 5G core network associated with location services. The positioning procedure may be initiated by an entity of the 5GC, by the AMF or by the UE, as is illustrated by steps 1a, 1b and 1c. For example, in step 1a, an entity in the 5GC, for example a gateway mobile location center, GMLC, may request a location service, like a positioning service, for the UE to the AMF serving the UE. Alternatively, as is illustrated in step 1b, the serving AMF of the UE may determine the need for a location service, for example to locate the UE for an emergency call. As yet another alternative, the UE, as is indicated at step 1c, may request a location service, for example, for determining its position or for requesting assistance data. The UE may request a location service from the serving AMF at the non-access stratum, NAS, level.

Following the request for the location service, at step 2, the AMF transfers the location service request the LMF. The LMF instigates at step 3a a location procedure with the gNB serving the UE and, optionally, with one or more neighboring gNBs, for example to obtain positioning measurements or assistance data. In addition to step 3a or instead of step 3a, the LMF may instigate the location procedure with the UE, for example to obtain a location estimate or positioning measurements or to transfer location assistance data to the UE.

At step 4, the LMF provides a location service response to the AMF and includes the results, for example a success or failure of the process and, if requested and obtained, the location estimate for the UE.

Then, in case step 1a was performed, the AMF returns in step 5a the location service response to the 5GC entity that requested the location service in step 1a and includes the results of the process, for example the location estimate for the UE. On the other hand, in case the location service was requested by step 1b, namely by the AMF, the AMF uses in step 5b the location service response received in step 4 to assist the service that triggered the AMF to request the location service, for example, the AMF may provide a location estimate associated with an emergency call to a GMLC. In case the location service was requested by the UE in step 1c, the AMF returns in step 5c the location service response to the UE and includes any of the results obtained by the location process, for example the location estimate for the UE.

According to Rel. 16, for the positioning procedure, the UE is to be in a connected state, like the RRC_CONNECTED state. However, Rel. 17 or future releases may also allow UE positioning to be enabled in a non-connected state, like the RRC_INACTIVE state or the RRC_IDLE state. However, in the positioning procedure described above with reference to FIG. 2, at least steps 1c, 3b and 5c require the UE to be in RRC_CONNECTED state so that the configuration and/or assistance data for the positioning procedure may be provided and/or updated. In the RRC_CONNECTED state, full data and signaling connectivity between the 5GC network and the UE is established, and at least the signaling bearers SRB0, SRB1, SRB2 and possibly also SRB3 are established. However, in the RRC_INACTIVE state or in the RRC_IDLE state, only the signal bearer SRB0 remains active, while the remaining signal bearers are suspended for the UE. Thus, procedures that require an update of certain parameters to be provided to the UE, for example, dependent on changing locations of the UE within the network, require
the UE to be in the RRC_CONNECTED mode, or
a signaling connection between the UE and the network that is supported in a non-connected state or a reduced connectivity state, such as signaling via broadcast transmission and/or signaling using the small data transmission (SDT) mechanism, or
a suitable mechanism for the UE to determine the parameters for obtaining positioning measurements.

Such procedures include the above-mentioned positioning procedure during which the UE performs positioning measurements, for example, measurements of reference signals transmitted by one or more TRPs in the vicinity of the UE and on the basis of which an actual position of the UE may be determined. Dependent on where the UE is located, a configuration of the positioning procedure may need to be updated, for example, in case the UE moves from one location to another location within the network area. Also in case the UE is provided with assistance data, like data assisting the UE for performing the positioning measurements at certain locations within the network, an update of such assistance data may be needed.

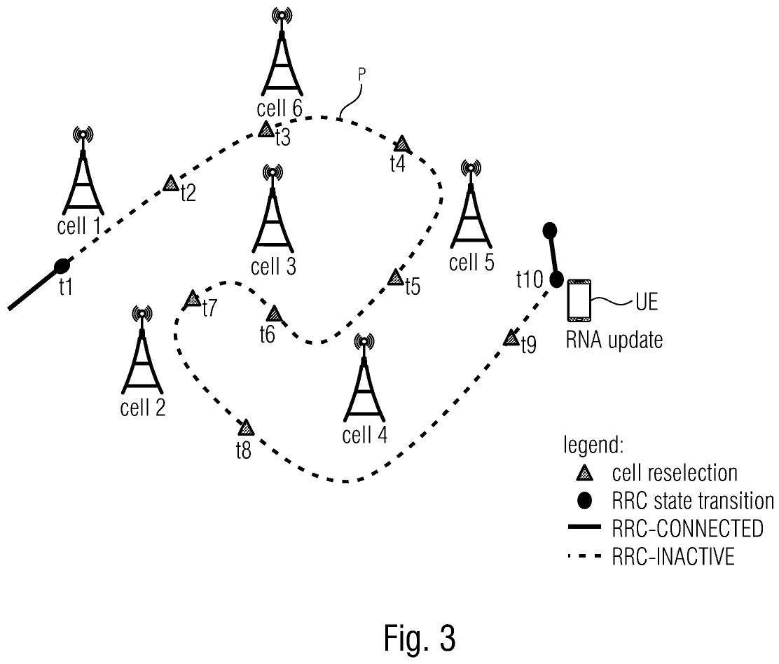

FIG. 3 schematically illustrates the mobility of a UE within a wireless communication network including six cells, namely cell 1 to cell 6. A path P along which the UE travels through the system is illustrated. Until a time t1, the UE is in the RRC_CONNECTED state, and, at the time t1, an RRC state transition occurs, namely the UE moves from the RRC_CONNECTED state to the RRC_INACTIVE state. The UE stays in the RRC_INACTIVE state until time t10 and the transitions back to the RRC_CONNECTED state. While being in the RRC_INACTIVE state, the UE moves around the network area, as is indicated by the dashed line P, and at certain times, e.g., at times t2 to t9, the UE performs a cell reselection so as to determine along the path P at the respective times the cell which has the best condition among all the cells on n which the UE is allowed to camp on. Thus, when considering the above-described positioning procedure, between time t1 and t10, the UE is not in the RRC_CONNECTED mode, so that steps 1c, 3b and 5c are not possible. During this time, the UE may not be provided with assistance data for supporting the UE's positioning measurements.

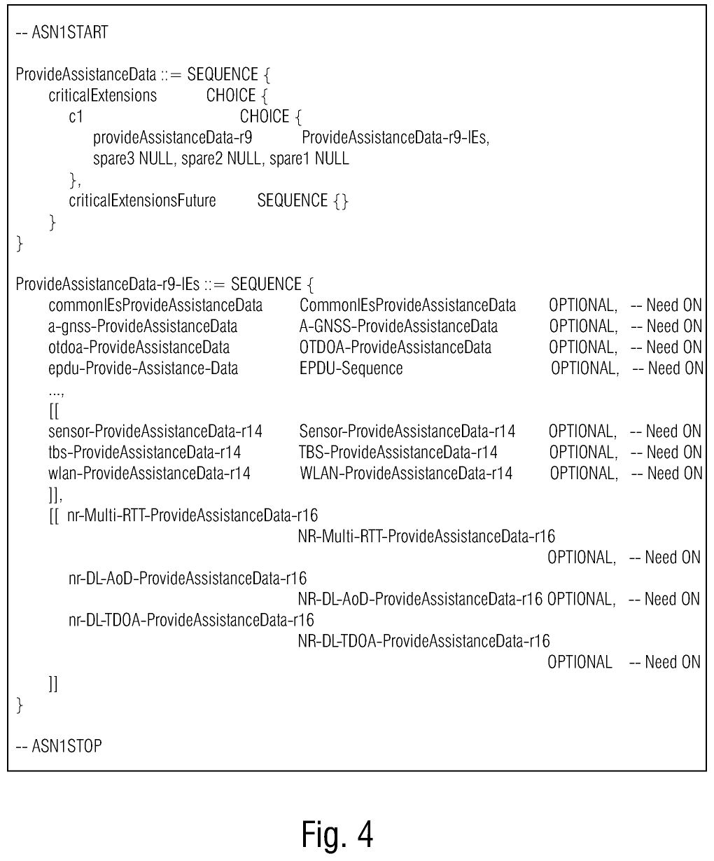

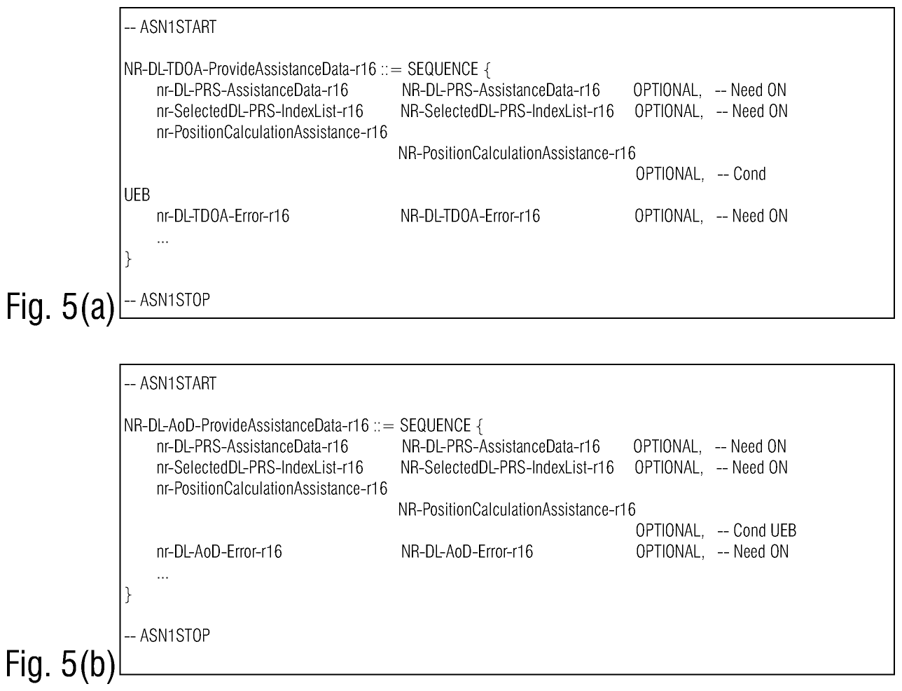

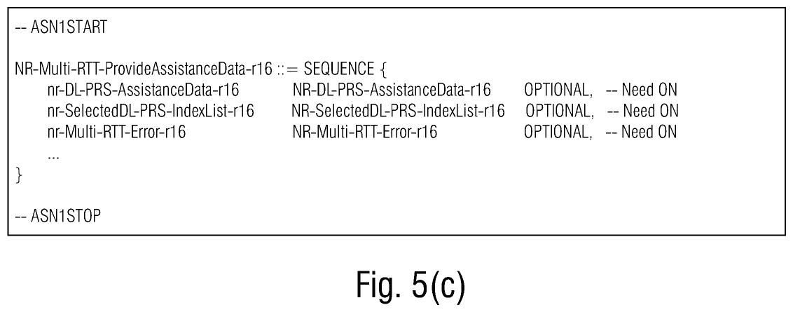

According to Rel. 16 of the 3GGP specification, a UE is provided with assistance data including a number of information elements, IEs, for example NR-DL-PRS-AssistanceData-r16, NR-selectedDL-PRS-IndexList-r16 for the methods using downlink positioning reference signals, DL-PRS, as the reference signals to be measured by the UE. When the UE is configured to perform measurements for more than one positioning method, assistance data is provided for any one of the methods the UE is configured perform measurements for. FIG. 4 illustrates an example of the IE ProvideAssistanceData applicable for Rel. 16 UE positioning. In addition, the UE may also receive assistance data about the transmission reception points, TRPs, to compute the data in a UE-based mode for Downlink Time Difference Of Arrival, DL-TDOA, or Downlink Angle-of-Departure, DL-AoD. Also an information element describing an error source for DL-TDOA, DL-AoD and Multiple-Round Trip Time, Multi-RTT, may be provided. FIG. 5 illustrates the assistance data that is applicable to UE positioning in TDOA, AoD and Multi-RTT in Rel. 16 UE positioning in RRC_CONNECTED state. FIG. 5(a) illustrates the assistance data for DL-TDOA, FIG. 5(b) illustrates the assistance data for DL-AoD and FIG. 5(c) illustrates the assistance data for Multi-RTT.

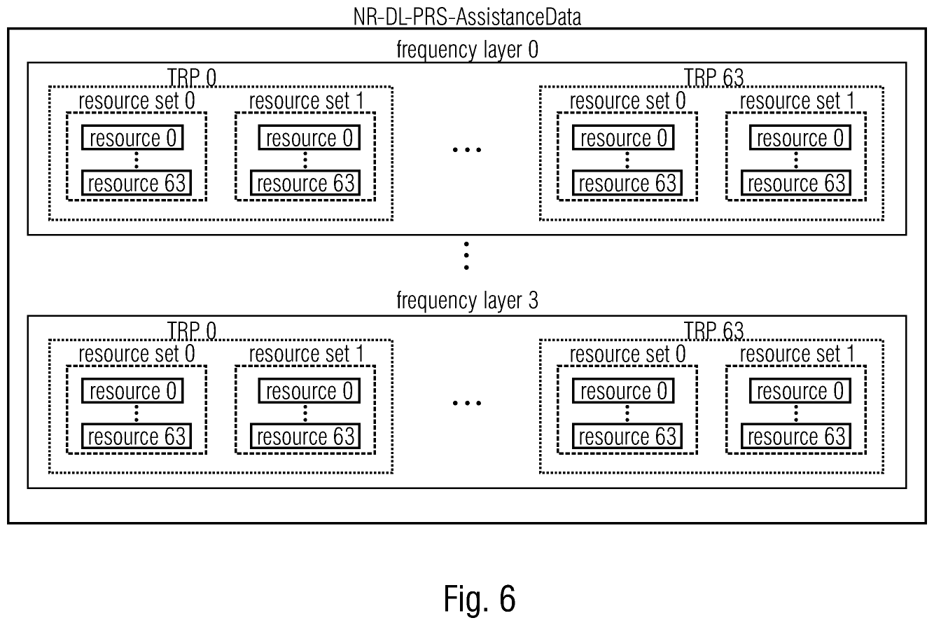

The assistance data described above with reference to FIG. 5 is described, for example, in TS 37.355. As is described, for example, in Rel. 16 TS 37.355, the IE NR-DL-PRS-AssistanceData organizes the information of DL-PRS-resource configurations in a hierarchy including the frequency layer, the TRP, the resource set and the resources. The information may be transmitted as a part of a broadcast information, for example in a positioning system information block, posSIB, of type posSIB type 6-1. FIG. 6 illustrates the IE NR-DL-PRS-AssistanceData according to Rel. 16 TS 37.355 in accordance with which the UE may be configured to measure up to a maximum of four frequency layers, 64 TRPs per frequency layer, two resource sets per TRP, and 64 resources per resource set.

Starting with Rel. 17, also UEs being in a non-connected state, like the RRC_INACTIVE state or the RRC_IDLE state, are planned to support positioning procedures, for example in case the UE moves from the RRC_CONNECTED to the RRC_INACTIVE state upon receiving an RRC_Suspend message including a suspend configuration, SuspendConfig, from the network. While being in the non-connected state, the UE is to perform a cell-reselection mobility and RNA-updates upon expiry of the time at T380 or upon camping on a cell outside the RAN-based notification area, RNA.

As described above with reference to FIG. 2, positioning sessions may be managed by the location management function, LMF, residing within the core network, whereas the RAN network is responsible for managing the RRC state. The positioning session, which may be initiated while the UE is in the RRC_CONNECTED state, may also provide the above-mentioned assistance data for a current location, like a current cell, at which the UE is currently located. However, the assistance data at the UE may become outdated as the UE moves around within the RNA when being in the RRC_INACTIVE state, or within a CN-paging area, when being in the RRC_IDLE state.

The present invention addresses a situation in which assistance data associated with a certain location of the UE or associated with a certain location of the UE and a certain time become outdated due to the UE moving around, while the UE is either in the connected state or in the non-connected state.

### First Aspect

In accordance with a first aspect of the present invention, a situation is addressed in which the UE performing positioning measurements transitions during the positioning session from the connected state, like the RRC_CONNECTED state, to a non-connected state, like the RRC_INACTIVE state or the RRC_IDLE state. The UE performs the positioning measurements on the basis of assistance data received, for example, by the LMF. To overcome the above-described problem that such assistance data may become outdated as the UE moves around the network area, in accordance with the first aspect of the present invention, the UE may receive assistance data, also referring to the following as AD, responsive to a paging of the UE. The UE may be paged during a paging occasion by the AMF or by the NG-RAN node serving the UE responsive to a message for the UE from the location server. Thus, in accordance with embodiments of the first aspect, a UE is provided that participates in a positioning procedures involving an LMF so as to perform positioning measurements when being in a non-connected state on the basis of assistance data, AD, that is obtained at the UE or received by the UE responsive to a paging of the UE.

Thus, the drawbacks experienced in conventional approaches, namely that assistance data may be outdated when the UE moves around the network area, are avoided as the UE may be provided with updated AD associated with a new UE location to which the UE moved from a location for which the existing AD was previously received. Thus, despite the fact that the UE is in a non-connected mode, it is still provided with actual AD thereby allowing the UE to efficiently and effectively perform the positioning measurements on the basis or by using the appropriate assistance data for the location where it is located, like the cell on which it camps.

### Second Aspect

A second aspect of the present invention also addresses the issue that assistance data, AD, may become outdated once the UE performing positioning measurements during a positioning session transitioned from the connected state into the non-connected state. In accordance with the second aspect, it is assumed that the UE received AD for the current location, and, when moving from the connected state to the non-connected state, for example responsive to the RRC_Suspend signaling, the UE may continue using the AD provided for the positioning measurements in the connected state. In other words, embodiments of the second aspect provide a UE that participates in a positioning procedure involving an LMF, and the UE performs positioning measurements. The UE includes assistance data for performing the measurements at a certain location, and continues to use this AD when moving to a non-connected state. According to the second aspect, the existing AD may be used by the UE as long as one or more predefined criteria are met.

Like the first aspect, also the second aspect avoids the problem of outdated AD. For example, for the time following the transition from the connected state to the non-connected state, the UE may be assumed to stay within the area where it was at the time of the transition so that the AD obtained during the connected state is treated as AD or assistance data for the non-connected state. Thus, situations are avoided in which the AD is considered to be outdated and, therefore, no longer used, due to the mere fact that the UE moved from the connected state into the non-connected state.

In accordance with embodiments of the second aspect, in case the one or more predefined criteria are no longer met, the AD may be considered outdated, and in such a situation, the second aspect and the first aspect may be combined, i.e., the UE may obtain actual or updated AD responsive to a paging, in accordance with the first aspect of the present invention.

### Third Aspect

In accordance with a third aspect, the present invention addresses the above problem of potentially outdated assistance data in case a UE, while performing positioning measurements during a position session, transitions from the connected state to the non-connected state, by initially providing the UE with assistance data that may be used both in the connected mode and in the non-connected mode. More specifically, in accordance with the third aspect, the assistance data the UE obtained at a certain location is extended so as to cover an area larger when compared to an area where the UE is located while it is in the RRC_CONNECTED state. In other words, the third aspect provides a UE participating in a positioning procedure involving an LMF and performing positioning measurements. The UE includes assistance data that is provided, for example, by the LMF in such a way that the assistance data not only assists performing the positioning measurements at the location at which the UE is located when receiving the AD, but also for an area going beyond the initial area, i.e. the assistance data covers an area larger than the area where the UE is located when it is in the RRC_CONNECTED state.

The third aspect is advantageous as it avoids the AD data to become quickly outdated, especially in situations where it is assumed that the UE, after switching to the non-connected mode, only roams within a small distance beyond the area where it was located when being in the connected mode. It is noted that the assistance data described above with regard to the first aspect and/or the second aspect may be extended in accordance with the third aspect. In other words, the third aspect may be combined with anyone of or both of the first aspect and the second aspect.

### Fourth Aspect

A fourth aspect of the present invention addresses the issue that, when moving around the network area, the UE which participates in a positioning session and provides positioning measurements may require different assistance data when being at different locations, for example when camping on different cells. This applies for situations in which the UE performs the positioning measurements in the connected state and/or in the non-connected state. In accordance with embodiments of the fourth aspect, the UE is provided with a set of assistance data from which the UE, when performing the measurements, selects the assistance data that is associated with a current location of the UE in the wireless communication network or with the current location of the UE in the wireless communication network and a current time. In other words, embodiments of the fourth aspect provide a UE that participates in a positioning procedure involving an LMF and performs positioning measurements using an AD set for assisting the positioning measurements at different locations at which the UE may be located in the network.

In accordance with the fourth aspect, the above drawbacks when operating in the non-connected mode are avoided, as the UE, even when switching from the connected state to the non-connected state and/or when the UE changes its location, may determine, responsive to the new location, the appropriate AD to be used for assisting the UE in performing the positioning measurements. Also when considering the UE to operate all the time in the connected state, the embodiments of the fourth aspect are advantageous, as at the time of determining a change of the position, only a minimum signaling, in case the position change is detected by the network, or even no signaling regarding the new position is needed for transferring the updated or new AD, as this information is already present in the UE.

It is noted that the fourth aspect may be combined with the first aspect by allowing the UE to request or the LMF to provide an update of one or more of the ADs of the AD set or of some AD components of an AD instance or instant of the AD set. Also, the fourth aspect may make use of one or more extended AD instances or instants in accordance with the third aspect. Further, in accordance with the fourth aspect, when switching from a connected mode to a non-connected state, the UE may continue to use a currently used AD in accordance with the second aspect, and once the one or more predefined criteria for making use of the current AD are no longer met, the UE may decide to determine its location, for example by performing a cell-reselection measurement, and to select on the basis of the obtained information about its location or about the cell on which it camps, the now appropriate AD from the AD set. Thus, the fourth aspect may be combined with one or more of the first aspect, the second aspect and the third aspect.

The use of providing multiple instances of AD, where each AD is applicable to a different area within the network, additionally helps reducing the signaling latency. Since the AD corresponding to the current location of the UE and/or AD corresponding to possible future locations of the UE are provided in advance, the UE may directly choose an AD instance from the set of configured AD without the need to invoke procedures for transferring AD, e.g. RequestAssistanceData and/or ProvideAssistanceData each a time positioning session is initiated. Furthermore, the ability of the UE to use the stored configured data corresponding to one or more locations of the UE enables the UE to perform positioning measurements without having to necessarily transit to the RRC_CONNECTED state in one or more non-connected states, like the RRC_INACTIVE or RRC_IDLE state). The above steps help reduce positioning latency.

Regarding the use of multiple instances, it is noted that, according to embodiments, the multiple AD instances may be
provided by giving multiple instances of ProvideAssistanceData within one or more positioning sessions, or
retrieved from the posSibs.

The above-described aspects of the present invention provide approaches or mechanisms of providing assistance data to a UE, for example during a first RRC state, like the RRC_CONNECTED state, in such a way that it may be used by the UE during a second RRC_STATE, like the RRC_INACTIVE state or the RRC_IDLE state or the RRC_CONNECTED state. Further aspects, which apply for all of the first, second, third and fourth aspects concern update mechanisms for the assistance data and how assistance data messages may be communicated between the respective network entities. It is noted that some embodiments are described with reference to the RRC_INACTIVE state only, i.e., that the assistance data is to be used during this state. However, the present invention and the respective embodiments thereof are not limited using the assistance data only during the RRC_INACTIVE state, rather, in accordance with other embodiments, the assistance data, AD, received in the RRC_CONNECTED state may also be applicable to or used in any other state, like the RRC_CONNECTED state.

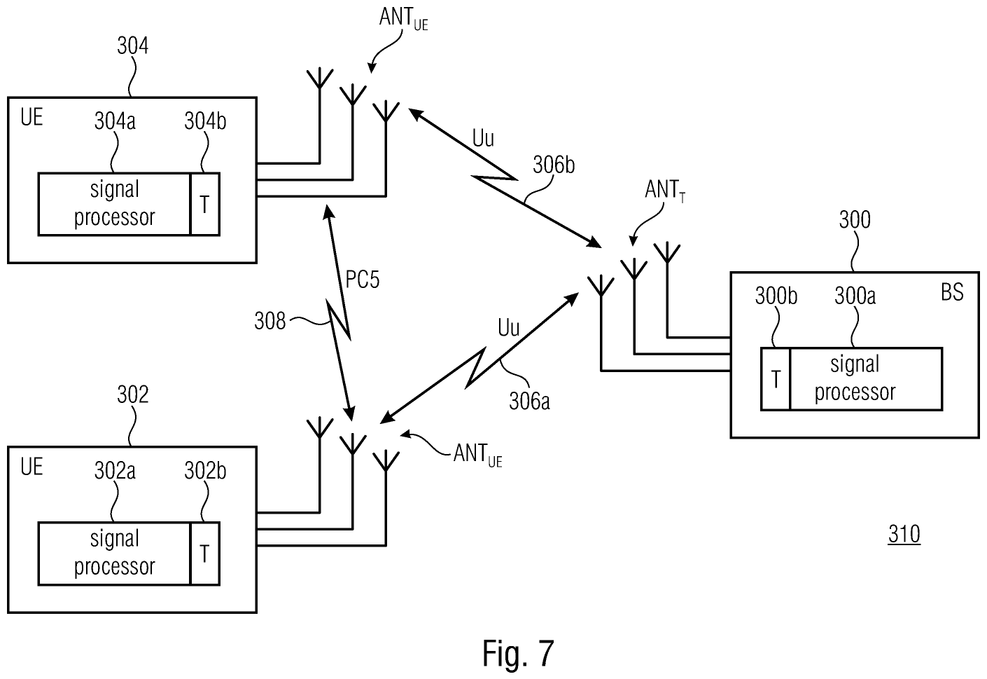

Embodiments of the present invention may be implemented in a wireless communication system as depicted in FIG. 1 including base stations and users, like mobile terminals or IoT devices. FIG. 7 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANTT or an antenna array having a plurality of antenna elements, a signal processor 300a and a transceiver 300b coupled with each other. The receivers 302, 304 include one or more antennas ANTuE or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5/sidelink, SL, interface. When the UEs are not served by the base station or are not connected to a base station, for example, they are not in an RRC connected state, or, more generally, when no SL resource allocation configuration or assistance is provided by a base station, the UEs may communicate with each other over the sidelink, SL. The system or network of FIG. 7, the one or more UEs 302, 304 of FIG. 7, and the base station 300 of FIG. 7 may operate in accordance with the inventive teachings described herein.

### USER DEVICE

### First Aspect—UE

The present invention provides a user device, UE, of a wireless communication network,
wherein, for determining a position of the UE in accordance with a positioning procedure, the UE is to perform positioning measurements,
wherein, when the UE is in a non-connected state, like an RRC_INACTIVE state or an RRC_IDLE state, the UE is to perform the positioning measurements in accordance with assistance data, AD, applicable for the UE at a current location of the UE in the wireless communication network, and
wherein, responsive to a paging of the UE, the UE is to receive the AD from a location server, like a location management function, LMF.

In accordance with embodiments, responsive to the paging
the UE is to move to a connected state, like an RRC_CONNECTED state, and receive the AD, and
after receiving the AD, the UE is to return to the non-connected state, e.g., responsive to a suspend signaling, like an RRC_Suspend signal, and start or continue the positioning procedure in the non-connected state.

In accordance with embodiments, responsive to the paging the UE is to remain in the non-connected state and receive the AD using a small data transmission, e.g., by using a MSG-B of a 2-step Random Access Preamble, RACH, procedure and/or using the regularly scheduled radio resources in the downlink, like semi-persistent or periodic scheduling of downlink resources applicable to RRC_INACTIVE or RRC_IDLE mode, for the UE or a group of UEs.

In accordance with embodiments, in responsive to the paging the UE is to remain in the non-connected state and transmit the positioning measurements to the location server using a small data transmission, e.g., by using a MSG-A of a 2-step Random Access Preamble, RACH, procedure and/or using the regularly scheduled radio resources in the uplink, like semi-persistent or periodic scheduling of uplink resources applicable to RRC_INACTIVE or RRC_IDLE mode, for the UE or a group of UEs.

In accordance with embodiments, responsive to a certain event, like the UE moving from the current location to a new location in the wireless communication network, the UE is to send to the location server a request for a new AD applicable for the UE to perform the positioning measurements.

In accordance with embodiments, the UE is to send the request via a small data transmission at a random access occasion, e.g., by using a MSG-A of a 2-step Random Access Preamble, RACH, procedure and/or using the regularly scheduled radio resources in the downlink, like semi-persistent or periodic scheduling of uplink resources applicable to RRC_INACTIVE or RRC_IDLE mode. for the UE or a group of UEs.

In accordance with embodiments, the paging of the UE is triggered by an radio network entity, like a serving cell, on a first interface, and assistance data for the location server is received on a second interface.

### First Aspect—LMF

The present invention provides a Location Management Function, LMF, apparatus for determining a position of a user device, UE, of a wireless communication network, which is in a non-connected state, like an RRC_INACTIVE state or an RRC_IDLE state, the apparatus comprising:
a position determining processor to determine, responsive to receiving from the UE positioning measurements,
wherein the apparatus is to provide the UE with assistance data, AD, for performing the positioning measurements in the non-connected state, the AD being applicable for the UE at a current location of the UE in the wireless communication network, and
wherein the apparatus is to provide the UE with the AD during a paging occasion for the UE.

In accordance with embodiments, the apparatus is to provide the AD in a broadcast mode, e.g., in case of a change of system information, or in a unicast mode, e.g., in case of detecting a movement of the UE form a current location to a new location in the wireless communication network, or responsive to a request from the UE.

In accordance with embodiments, the apparatus is provided in a core network, CN, entity of the CN of the wireless communication network, or in a radio access network, RAN, entity of the RAN of the wireless communication network.

### Second Aspect

The present invention provides a user device, UE, of a wireless communication network,
wherein, for determining a position of the UE in accordance with a positioning procedure, the UE is to perform positioning measurements,
wherein the UE is in a connected state, like an RRC_CONNECTED state, and is to perform the positioning measurements in accordance with assistance data, AD, applicable for the UE at a current location of the UE in the wireless communication network, and
wherein, responsive to changing from the connected state to a non-connected state, like an RRC_INACTIVE state or an RRC_IDLE state, the UE is to continue using the AD as long as one or more predefined criteria are met.

In accordance with embodiments, responsive to changing from the connected state to a non-connected state, like the RRC_INACTIVE state or the RRC_IDLE state, and subsequently back to the connected state, like the RRC_CONNECTED state, the UE is to continue using the AD as long as one or more predefined criteria are met.

In accordance with embodiments, the one or more predefined criteria comprise one or more of the following:
the UE remains at the current location in the wireless communication network,
the UE is at a certain location in the wireless communication network for which the AD is valid,
an expiration time associated with the AD has not lapsed.

### Third Aspect

The present invention provides a user device, UE, of a wireless communication network,
wherein, for determining a position of the UE in accordance with a positioning procedure, the UE is to perform positioning measurements,
wherein, when the UE is in a non-connected state, like an RRC_INACTIVE state or an RRC_IDLE state, the UE is to perform the positioning measurements in accordance with assistance data, AD, obtained for a certain area when the UE was in a connected state, and
wherein the AD is extended so as to cover an area that is larger than the certain area.

In accordance with embodiments, the UE is to apply at least one of the AD information of the extended AD in the non-connected state on one or more of the measurements.

### Fourth Aspect

The present invention provides a user device, UE, of a wireless communication network,
wherein, for determining a position of the UE in accordance with a positioning procedure, the UE is to perform positioning measurements,
wherein the UE comprises an assistance data, AD, set, the AD set including a plurality of assistance data, AD, instances, each AS instance applicable for the UE to perform the positioning measurements at a certain location in the wireless communication network, and
wherein the UE is to perform the positioning measurements in accordance with the assistance data, AD, instance applicable for the UE at a current location of the UE in the wireless communication network.

In accordance with embodiments, for obtaining the AD set, the UE is to
receive the AD set form the wireless communication network, e.g., from the LMF, and/or
collect the AD instances while moving around in the wireless communication network.

In accordance with embodiments, for collecting the AD instances, when moving from a current location to a new location in the wireless communication network and receiving for the new location a new AD instance, the UE is to maintain or store the new AD instance together with one or more existing AD instances applicable for other locations.

In accordance with embodiments, the UE is to receive the AD set or is to start to collect the AD instances
when entering a non-connected state, like an RRC_INACTIVE state or an RRC_IDLE state, or
when connecting to the network, e.g., when entering a connected state, like an RRC_CONNECTED state, or
when the UE is connected to the network, e.g. when there is a signaling connection according to a certain positioning protocol, like the LTE Positioning Protocol, LPP, between an element of the network, like the LMF, and the UE.

In accordance with embodiments, the UE is to determine its current location in the wireless communication network, and activate an AD instance from the AD set that corresponds to or is associated with the current location of the UE.

In accordance with embodiments, an area of the wireless communication network where an AD instance is applicable is indicated by an AD area identifier, and wherein the UE is to activate an AD instance from the AD set that has an AD area identifier that matches an area identifier for the current location of the UE. As an example of an area identifier, the IE Area-ID-CellList-r17 may be provided within the position method specific ProvideAssistanceData methods such as NR-DL-TDOA-ProvideAssistanceData, NR-DL-AoD-ProvideAssistanceData, NR-Multi-RTT-ProvideAssistanceData. The IE Area-ID-CellList-r17, thus, provides a list of cells where the AD instance is applicable. The cells themselves may be identified using at least one of the following parameters NR global cell identifier (NGGI), physical layer cell ID (NR-PhysCellID) or NR-ARFCN (absolute radio frequency channel number). The IE in this example may be realized in a high layer interface (LPP) in ASN.1 syntax such as:
area-ID-CellList-r17 Area-ID-CellList-r17 OPTIONAL--Need ON

In accordance with embodiments, the UE is to obtain the UE area identifier corresponding to the current location of the UE by one or more of the following:
a signaling, like a unicast message,
a system information,
a measurement the UE performs on certain reference signals.

In accordance with embodiments, the area identifier identifies a certain part or sub-area of the wireless communication network, e.g., of a notification area where the UE is reachable within the wireless communication network, like a RAN Notification Area for a UE being in an RRC_INACTIVE state, or a Tracking Area for a UE being in an RRC_IDLE state.

In accordance with embodiments, an AD instance is associated with one or more validity states, the one or more validity states including one or more of the following:
a spatial validity for indicating whether an applicability area with which the AD instance is associated matches a current area or location where the UE is located, and
a temporal validity for indication whether a time since providing the AD instance to the UE is within a predefined time period before the AD expires.

In accordance with embodiments, the applicability area comprises one or more of the following:
a RAN notification area and/or a Tracking area,
a system information area,
a positioning system information area,
a cell,
a certain portion of a cell, or a certain portion of the RAN notification area or
a certain portion of the system information area or a certain portion of the positioning system information area, denoted, e.g., by an area identifier,
a combination of portions of one or more cells, which may be denoted by an area identifier,
a combination of one or more of the above.

In accordance with embodiments,
an AD instance is assigned at least one of the following validity states: ACTIVE, DEACTIVATED, EXPIRED, INVALID, and
wherein
   an AD instance is assigned an active state in case
the area identifier computed by the UE or provided to the UE by the wireless communication network matches the applicability area for the AD instance, and
a time elapsed since acquiring the AD instance is within the predefined time period,
   an AD instance is assigned a deactivated state incase
the area identifier computed by the UE or provided to the UE by the wireless communication network does not match the applicability area for the assistance data, while a time elapsed since acquiring the AD instance is within the predefined time period,
   an AD instance is assigned an expired state in case
a time elapsed since acquiring the AD instance exceeds the predefined time period, wherein the UE may store the AD instance so as to allow the expired AD instance to be refreshed responsive to a signaling of a continued validity of the AD instance, causing the expired AD instance to be moved either to a deactivated state or to an active state,
   an AD instance is assigned an invalid state in case
a time elapsed since acquiring the AD instance exceeds the predefined time either the validity time is exceeded and the AD is not refreshed, or the wireless communication network signals configuration change to the UE, wherein the UE may delete the invalid AD instance.

In accordance with embodiments, for indicating, e.g., to the LMF, capabilities of the UE with regard to the handling of the AD instances, the UE is to signal
the validity states supported by the UE, e.g., the UE may signal that it only stores an active AD instance, or an active AD instance and a deactivated AD instance, or an expired AD instance, and/or
that AD instances not corresponding to a current applicability area are stored, and/or
a number of expired AD instances the UE stores, and/or
a time period during which the UE stores expired AD instances.

In accordance with embodiments, to signal that AD instances not corresponding to a current applicability area are stored, the UE is to
set a flag a certain value, thereby indicating that the UE stores AD corresponding to an area outside the current applicability area, or
directly indicate the areas which the UE may store AD, e.g., by indication a number of PRS-ID+cell ID combinations for which the UE may store AD using the UE capability signaling.

In accordance with embodiments, the UE is to select an AD instance from the AD set
responsive to a signaling, e.g., by the LMF, of the selection of the AD instance, and/or
by associating measurements by the UE and/or a certain part of system information acquired by the UE with an AD instance.

In accordance with embodiments, the UE is to receive a signaling to select a certain one of the AD instances from the AD set as an active AD instance, wherein the signaling may optionally indicate an applicability of the active AD instance to different connection states, likes RRC states, and positioning modes, like a UE-assisted mode or a UE-based mode.

In accordance with embodiments, the signaling is
transmitted as a part of positioning system information or
is received by the UE in a unicast mode,
is relayed to the UE via other components of the wireless communication network.

In accordance with embodiments, the UE is to be provided with a configuration that maps measurements of the UE and/or a certain part of the system information acquired by the UE to a one or more AD instances from the AD set.

In accordance with embodiments, an AD instance is associated with a certain area that is indicated by an area identifier, and wherein the UE is to
obtain the area identifier of the area where it is located, e.g., by
   reading the system information, or
   determining the cell where the UE is camped, e.g., by using cell-reselections measurements or an New Radio, NR, Cell Global Identifier, or
   measurements on certain downlink reference signals, DL-RS, and
compare the area indicated by the area identifier of the AD instance and the area indicated by the area identifier of the UE location, so as to determine whether the AD instance is to be marked an active AD instance or not.

In accordance with embodiments, the AD set is configured with a predefined parameter, e.g., a ValidityScope and/or an ApplicabilityScope, the parameter indicating at least an area within a notification area where the AD set is applicable, and wherein the parameter may further indicate one or more of the following:
a states for the AD set, e.g., active, deactivated, expired or invalid,
whether the AD set is applicable to a certain positioning mode, like a UE-assisted mode, a UE-based mode, an RRC_INACTIVE mode, an RRC_CONNECTED mode, an RRC_IDLE mode or combinations thereof.

In accordance with embodiments, in case the predefined parameter is not present, the UE is to assume the AD set to be applicable until a new AD set is provided for a UE.

In accordance with embodiments, the UE is to perform the positioning procedure in non-connected state, like an RRC_INACTIVE state or an RRC_IDLE stat, and responsive to the paging
the UE is to move to a connected state, like an RRC_CONNECTED state, and receive the AD, and, after receiving the AD, the UE is to return to the non-connected state, e.g., responsive to a suspend signaling, like an RRC_Suspend signal, and start or continue the positioning procedure in the non-connected state, or
the UE is to remain in the non-connected state and receive the AD using a small data transmission, e.g., by using a MSG-B of a 2-step Random Access Preamble, RACH, procedure and/or using the regularly scheduled radio resources in the downlink, like semi-persistent or periodic scheduling of downlink resources applicable to RRC_INACTIVE or RRC_IDLE mode, for the UE or a group of UEs.

In accordance with embodiments, responsive to the paging the UE is to remain in the non-connected state and transmit the positioning measurements to the location server using a small data transmission, e.g., by using a MSG-A of a 2-step Random Access Preamble, RACH, procedure and/or using the regularly scheduled radio resources in the downlink, like semi-persistent or periodic scheduling of uplink resources applicable to RRC_INACTIVE or RRC_IDLE mode, for the UE or a group of UEs.

### All Aspects

In accordance with embodiments,
when the positioning procedure operates in an UE-Assisted mode, the location server knows the location of the UE, e.g., from a last reporting period, and the location server determines whether any AD component previously provided to the UE needs to be updated, wherein the location server may send the AD via a RAN entity, like a gNB hosting a cell, using a certain protocol, e.g., in a NR Positioning Protocol-Annex, NRPPa, message in case the AD is broadcast, or in a LTE Positioning Protocol, LPP, message in case the AD is unicast via the gNB to the UE,
   from where the UE last sent measurements either in connected state or in non-connected state, or
   where the UE initiated an RAN-based Notification Area, RNA, update procedure, and
when the positioning procedure operates in an UE-Based mode, the UE is to send an AD request to the location server if the UE determines that AD provided in unicast mode are not suitable for determining the position, wherein the UE may optionally send the area identifier where the UE is currently located, so that the location server may provide updated assistance data to the UE.

In accordance with embodiments, when the UE moves outside the notification area, the UE is to
discard all AD held by the UE,
initiate an RNA update or a Tracking Area Code, TAC, update,
acquire a new positioning configuration
   from a broadcast by a camped cell ,or
   by sending a request for AD, the request indicating the new RNA or TAC area.

In accordance with embodiments, the UE is to receive the AD or AD instance or an update of the AD or AD instance in a Positioning System Information Block, posSIB, the posSIB including the AD or AD instance, and, optionally, AD information, like validity area, indicated by area indicator and validity time, and AD version.

In case of a broadcast, the assistance data elements or components are mapped to a positioning system information broadcast (posSib) as follows:
posSibType6-1 contains the IE NR-DL-PRS-AssistanceData,
posSibType6-2 contains the IE NR-UEB-TRP-LocationData,
posSibType6-3 contains the IE NR-UEB-TRP-RTD-Info,
posSibType6-4 contains the IE NR-TRP-BeamAntennaInfo,
posSibType6-5 contains the IE NR-DL-PRS-TRP-TEG-Info,
posSibType6-6 contains the IE NR-On-Demand-DL-PRS-Configurations.

The IE Area-ID-CellList-r17 may be transmitted in a new SIB, which may be indicated using an identifier posSibType6-7. The IE Area-ID-CellList-r17 then indicates the applicability area. In other words, the Area-ID-CellList-r17 provides the list of cells where the corresponding AD elements are valid when the UE is camped within or connected to one of the cells contained in the list given by the Area-ID-CellList-r17.

In a scenario, a cell may broadcast multiple instances within a cell. In this case, an instance contains at least one AD element (e.g. NR-DL-PRS-AssistanceData) and the Area-ID-CellList-r17, mapped to a SI message. A UE may be able to decode a SI message by searching for DCIs scrambled with a SI-RNTI within a predefined window, which is the standard procedure for receiving SI messages. All SI messages that contain the same Area-ID-CellList-r17 transfer jointly the AD of one instance. If the cells mapped in Area-ID-CellList-r17 differ and/or the identifier of Area-ID-CellList-r17 differs, then they may be mapped to different instances. If the Area-ID-CellList-r17 is not present, then the AD may be considered valid within a default applicability scope. The default applicability scope may be either the cell where the posSib was received or the whole system information area.

In an alternative scenario, a cell may only broadcast the instance of the assistance data corresponding to the validity area the cell belongs to. The applicability area may be the broadcasted Area-ID-CellList-r17. When a UE visits another cell belonging to the same applicability area or the UE returns back to one of the cells in the given validity area, after having left the validity area for the given AD, the UE may use the AD without having to acquire and/or reacquire the positioning system information broadcast first.

The AD transmitted through the broadcast may be subject to a validity time configured within the posSib and/or an implicit validity time.

In accordance with embodiments, the AD for the positioning procedure comprises one or more of the following AD parameters:
a number of frequency layers,
a number of Transmission Reception Points, TRPs, per frequency layer,
a number of resource set per TRP,
a number of resources per resource set,
an area and/or a duration where the AD is to be considered valid, a priority of the order in which reference signal resources for the positioning procedure, like the downlink positioning reference signal, DL-PRS, are to be processed,
a delivery or transmit mechanism for the AD.

In accordance with embodiments, an AD or an AD instance for the positioning procedure to be performed by the UE in the connected state, like an RRC_CONNECTED state, differs in at least one or more AD components from an AD or an AD instance for the positioning procedure to be performed by the UE in the non-connected state, like an RRC_INACTIVE state or an RRC_IDLE state.

In accordance with embodiments, at least one or more AD components of an AD or an AD instance differ in their validity and/or applicability, e.g., some AD components may be valid for wider area than other AD components, or may be applicable to more UEs than other AD components.

In accordance with embodiments, the AD or the AD instance comprises one or more of the following AD components:
an AD component regarding a configuration of DL reference signals,
an AD component for selecting a subset of DL-PRS signals for measurements corresponding to one or more positioning methods,
an AD component regarding the priority of the order in which the DL-PRS signals are to be measured,
an AD component for determining a validity information of the AD,
an AD component regarding an applicability of the AD.

In accordance with embodiments, the AD component regarding a configuration of DL reference signals for the positioning procedure to be performed by the UE in the non-connected state accommodates a number of TRPs that is larger than a number of TRPs in an AD component regarding a configuration of DL reference signals for the positioning procedure to be performed by the UE in the connected state.

In accordance with embodiments, for AD components for the positioning procedure to be performed by the UE in the non-connected state,
the UE is to receive an AD component for selecting a subset of DL-PRS signals for measurements corresponding to one or more positioning methods each time the wireless communication network, like the LMF, determines that different resources are to be selected by the UE for a given positioning method, or
the UE is preconfigured with several sets of AD components for selecting a subset of DL-PRS signals for measurements corresponding to one or more positioning methods, and the UE is to select the DL-PRS the UE needs to measure during the non-connected state for every method, e.g., responsive to a signaling from the wireless communication network, like the LM.

In accordance with embodiments, the AD component regarding the priority of the order in which the DL-PRS signals are to be measured comprises:
a priority list referring to resources in the AD component regarding a configuration of DL reference signals and/or the AD component for selecting a subset of DL-PRS signals for measurements corresponding to one or more positioning methods, or
information for determining the priority list using a measurement on downlink reference signals, like a Synchronization Signal Block, SSB, the UE is configured with for measurement for the mobility management.

In accordance with embodiments,
the UE is to receive one or more AD components of the AD or AD instance in accordance with one or more of the following:
   in a single message or distributed between one or more messages,
   in a unicast message,
   in a multicast message,
   in a groupcast message,
   in a broadcast message,
   in a combination of any one of a unicast message and/or a broadcast message and/or a message groupcast and/or a multicast message, and
the UE, after receiving the AD components of the Ad, is to combine the received AD components to form the AD or AD instance.

In accordance with embodiments,
in case the UE receives same AD component by more than one of the unicast message, the multicast message, the groupcast message, and the broadcast message, the UE is to use the AD component received by a messages associated with a highest priority, wherein the unicast message has a priority higher than the multicast message, the multicast message has a priority higher than the groupcast message, and the groupcast message has a priority higher than the broadcast message, and/or wherein the priorities of different messages may be specified according to some fixed rules and/or may be signaled to the UE,
in case same AD components are missing in the broadcast message, but are provided by one or more of the unicast message or the multicast message or the groupcast message, the UE is to combine the AD components from the broadcast message and the unicast or multicast or groupcast message.

In accordance with embodiments,
responsive to receiving a new broadcast message including one or more AD components that is changed when compared to a previous broadcast message, in case an AD component provided via a previous unicast message has not associated any expiration time, the UE is to employ the AD component from the unicast message used together with AD components from a previous broadcast message together with the AD components from the new broadcast message, and/or
in case a combination of AD components of two or more of the unicast or multicast or groupcast or broadcast messages cause an inconsistent AD configuration, the UE is to drop the obtained AD or AD instance and is to use a previous AD of AD instance.

In accordance with embodiments,
the UE is configured with one or more AD components by one or more of the multicast message, the groupcast message and the broadcast message, and
responsive to receiving an AD component via a unicast message, the UE is to overwrite the corresponding AD component received by one or more of the multicast message, the groupcast message and the broadcast message, or
responsive to determining an AD component to be not needed, the UE is to omit the corresponding AD component received by one or more of the multicast message, the groupcast message and the broadcast message.

In accordance with embodiments, an AD or an AD instance is applicable for the UE at the current location of the UE and for the current time.

In accordance with embodiments, the UE is to signal its capability to perform the positioning procedure in a non-connected mode.

In accordance with embodiments,
the UE is in a Registration Management registered, RM-REGISTERED, mode, wherein the UE is to be paged by the wireless communication network either via core-network paging or via RAN-paging,
a location server, e.g. an LMF, has at least one positioning session, like a LPP session, for a UE, in response to a mobile originated, MO, network initiated, NI, mobile terminated, MT, a deferred mobile originated, D-MO, or a deferred mobile terminated, D-MT, positioning session, and
   the location server is to communicate with any NG-RAN node, such as a gNB, a ng-eNodeB, a TRP, a TP, a RP, which is reachable via the Access and Mobility Function, AMF, with signaling access to both location server and the NG-RAN node.

In accordance with embodiments, the positioning procedure operates in accordance with one or more of the following positioning methods:
angle of arrival, AoA,
angle of departure, AoD,
time of arrival, ToA,
time of flight, ToF,
time difference of arrival, TDOA, like OTDOA and UL-TDOA
enhanced Cell ID,
NR-Multi-RTT.

In accordance with embodiments, the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### SYSTEM

The present invention provides a wireless communication system, comprising one or more of the inventive user devices, UEs.

In accordance with embodiments, the wireless communication system further comprising one or more RANs and a CN, wherein the location server is part of the RAN or of the CN, and wherein a RAN entity comprises one or more of the following: a macro cell base station, or a small cell base station, or a central unit of a base station, or a distributed unit of a base station, or a road side unit (RSU), or a UE, or a group leader (GL), or a relay or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

### METHODS

The present invention provides a method for operating a user device, UE, of a wireless communication network, the method comprising:
performing, by the UE, positioning measurements to be used for determining a position of the UE in accordance with a positioning procedure,
wherein, when the UE is in a non-connected state, like an RRC_INACTIVE state or an RRC_IDLE state, the positioning measurements are performed in accordance with assistance data, AD, applicable for the UE at a current location of the UE in the wireless communication network, and
wherein, responsive to a paging of the UE, the AD is received from a location server, like a location management function, LMF.

The present invention provides a method for operating a user device, UE, of a wireless communication network, the method comprising:
performing, by the UE, positioning measurements to be used for determining a position of the UE in accordance with a positioning procedure,
wherein, in a connected state, like an RRC_CONNECTED state, and the positioning measurements are performed in accordance with assistance data, AD, applicable for the UE at a current location of the UE in the wireless communication network, and
wherein, responsive to changing from the connected state to a non-connected state, like an RRC_INACTIVE state or an RRC_IDLE state, continuing using the AD as long as one or more predefined criteria are met.

The present invention provides a method for operating a user device, UE, of a wireless communication network, the method comprising:
performing, by the UE, positioning measurements to be used for determining a position of the UE in accordance with a positioning procedure,
wherein, when the UE is in a non-connected state, like an RRC_INACTIVE state or an RRC_IDLE state, the positioning measurements are performed in accordance with assistance data, AD, obtained for a certain area when the UE was in a connected state, and
wherein the AD is extended so as to cover an area that is larger than the certain area.

The present invention provides a method for operating a user device, UE, of a wireless communication network, the method comprising:
performing, by the UE, positioning measurements to be used for determining a position of the UE in accordance with a positioning procedure, wherein the UE comprises an assistance data, AD, set, the AD set including a plurality of assistance data, AD, instances, each AS instance applicable for the UE to perform the positioning measurements at a certain location in the wireless communication network, and
   wherein the positioning measurements are performed in accordance with the assistance data, AD, instance applicable for the UE at a current location of the UE in the wireless communication network.

### COMPUTER PROGRAM PRODUCT

Embodiments of the present invention provide a computer program product comprising instructions which, when the program is executed by a computer, causes the computer to carry out one or more methods in accordance with the present invention.

In the following, embodiments of the present invention are described in more detail. The following non-limiting assumptions regarding the wireless communication network may apply. The UE is assumed to be in a radio management registered, RM-registered, mode and may be paged by the network either via core-network paging or via RAN-paging. The location server, like the LMF, handles at least one positioning session, like an LTE positioning procedure, LPP, session for a UE, which may be a positioning session that is mobile originated, MO, network initiated, NI, mobile terminated, MT, deferred mobile originated, D-MO, or deferred mobile terminated, D-MT. The LMF may communicate with any of the NG-RAN nodes in the network, for example a gNB, a ng-eNodeB, a TRP, a transmission point, TP, a reception point, RP, which is reachable via the AMF which, in turn, has signaling access to both the LMF and the NG-RAN node.

In accordance with embodiments of the present invention, a network entity, like the LMF or the NG-RAN node, may provide a UE with assistance data to be used when performing positioning measurements during a positioning session. The assistance data may indicate at least one or more of the following parameters mentioned above with reference to FIG. 6:
a number of frequency layers,
a number of TRPs per frequency layer,
a number of resource sets per TRP,
a number of resources per resource set,
an indication of an area and/or a duration where/during which the assistance data may be considered valid,
a priority of an order in which resources associated with reference signals, like downlink positioning reference signals, DL-PRSs, are to be processed by the UE,
a delivery or transmit mechanism for the assistance data like a unicast, a multicast, a groupcast or a broadcast. For example, the AD for RRC_CONNECTED may be delivered in unicast mode, but an AD for RRC_IDLE in broadcast mode. It is noted that the AD provided may differ in the mechanism of delivery but not necessarily in the content itself.

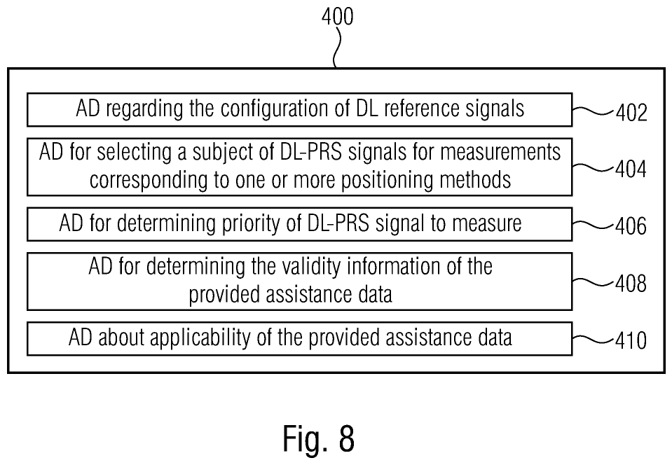

In accordance with embodiments, the assistance data, AD, may comprise one or more AD components. FIG. 8 illustrates an embodiment of a structure of positioning assistance data that may be employed by a UE for performing positioning measurements during a positioning session, either in the connected state or in the non-connected state. Assistance data, AD, 400 may include one or more of the following components or AD components:
an AD 402 regarding the configuration of DL reference signs,
an AD 404 for selecting a subset of DL-PRS signals for measurements corresponding to one or more positioning methods,
an AD 406 for determining a priority of the DL-PRS signal to measure,
an AD 408 for determining a validity information associated with the assistance data,
an AD 410 about the applicability of the assistance data.

In accordance with embodiments, the different components of the assistance data may be transmitted within a single message or they may be distributed among two or more messages. The UE may receive the assistance data as a unicast message, as a multicast message, as a groupcast message or as a broadcast message. In accordance with other embodiments, the respective components may be transmitted to a UE in a combination of any one of two or more of the above-mentioned messages, for example in a combination of a unicast message and/or a broadcast message and/or a groupcast message and/or multicast message. The UE may receive the different AD components and combine them so as to form the assistance data, AD, or AD instance 400 to be used by the UE or to be forwarded to different layers in the protocol stack.

### First Aspect

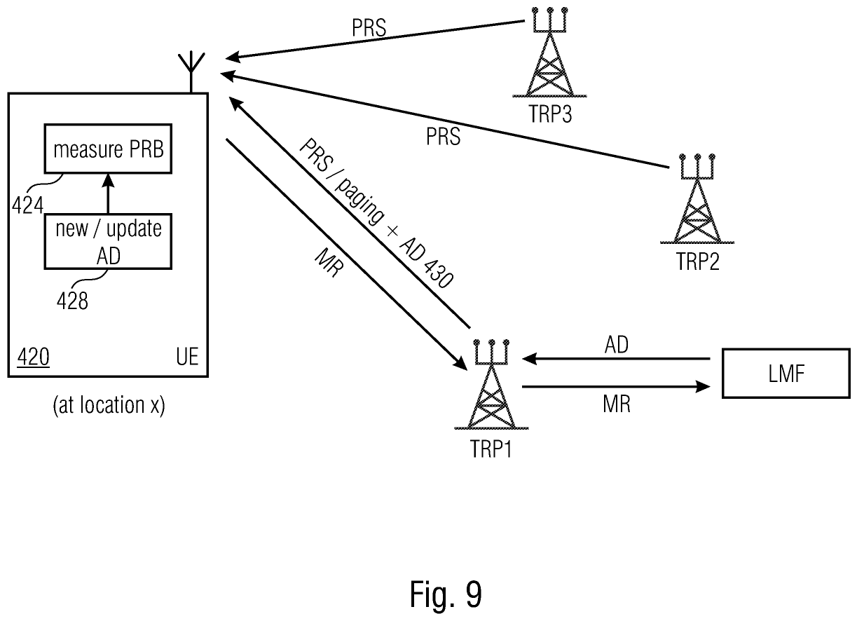

Embodiments of a first aspect of the present invention are now described in more detail. FIG. 9 schematically illustrates a part of a wireless communication system, like the system described above with reference to FIG. 1, in which a UE 420 in accordance with embodiments of the first aspect of the present invention is provided. The wireless communication system or network includes, in addition to the UE 420 which is assumed to be at a current location x within the network area, also a plurality of transmit and reception points, TRP₁-TRP₅, like a base station or gNB. TRP₁ serves the UE and provides for a connection between the UE 420 and the LMF 422 which may be part of the core network or the RAN. During a positioning session hosted by the LMF 422, UE 420 is to perform positioning measurements. In case of a UE-assisted positioning session, the UE provides the measurement results, MR, to the LMF so that a position, like the geographical position, of the UE 420 may be estimated by the LMF. In case of a UE-based positioning session, the UE uses the measurement results, MR, is self for estimating its position, like the geographical position, i.e., the MR may not be provided to the LMF. The TRPs transmit respective reference signals, like positioning reference signals, PRSs, that are measured by the UE 420, as is indicated at 424. The UE 420, for performing the positioning measurement 424, is supported by assistance data, AD, 426.

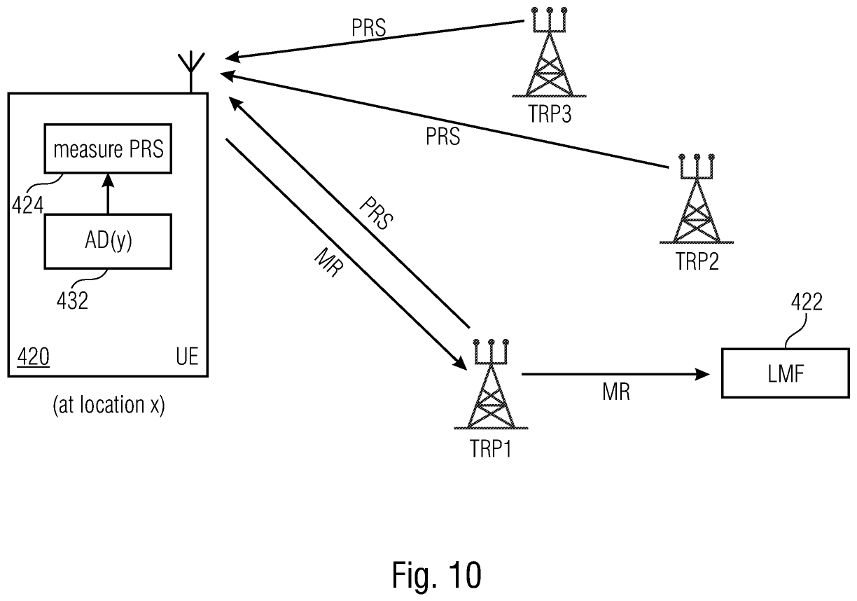

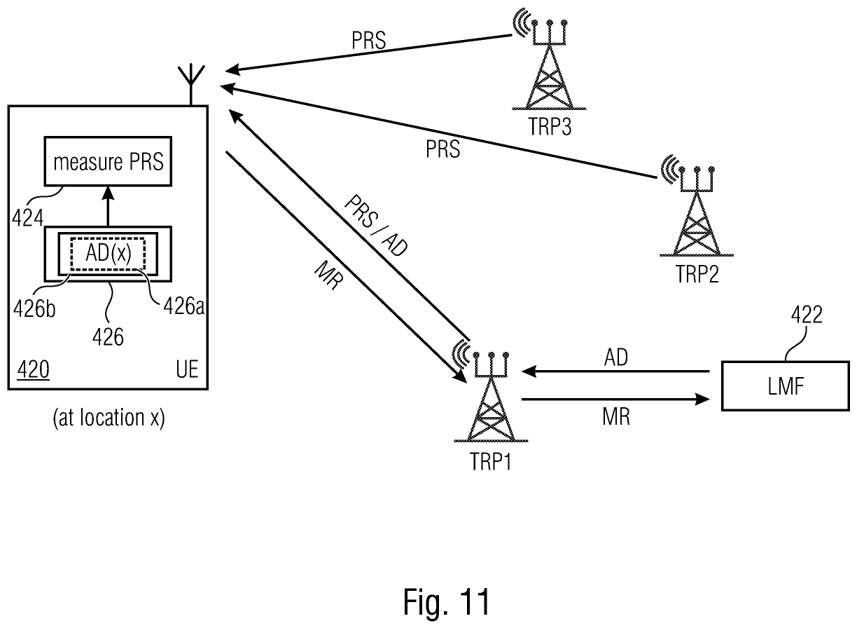

In accordance with the embodiments of the first aspect of the present invention, the UE 420 may operate at location x in the non-connected mode. The UE 420, when being in a connected state at a different location was provided with AD for assisting the positioning measurements for the positioning session and then, without being provided with a new AD for a new location, switched from the connected state to the non-connected state and moved to location x. In accordance with other embodiments, the UE did not include any AD and the positioning session started only once the UE was in the non-connected state. In either situation, in accordance with embodiments of the first aspect of the present invention, the UE needs to be provided with an updated AD for the location x, in case a previous AD is no longer valid, or the UE 420 is provided with an AD for the first time as no AD was previously stored. In accordance with embodiments of the first aspect, in such a situation, during a paging occasion, the LMF 422, via the AMF or the gNB, may provide the new or updated AD 428 to UE 420, as is indicated at 430 in FIG. 10.

Thus, in accordance with embodiments, to deliver the assistance data when the UE 420 is in the non-connected state, the UE may be paged and, following the paging process, may receive the appropriate, like new or updated, assistance data. For example, if the LMF 422 provides the new or updated assistance data in a broadcast mode, the NG-RAN node or the AMF may page the UE 420 for informing it about the change of system information, and by providing the new system information, like the posSIB, the new or updated assistance data may be provided to the UE 420. In accordance with other embodiments, the LMF may deliver the assistance data to the UE in a unicast mode and signals to the UE that it is paging for a mobile terminated signal connection. In accordance with yet other embodiments, the UE, during a paging occasion, may send a request for the assistance data, for example due to the UE detecting a change in the environment or a change in its location requiring new AD.

In accordance with embodiments, when being paged, the UE may move to the RRC_CONNECTED state and receive the assistance data or request and receive the assistance data, and after receiving the assistance data the network may provide an RRC_Suspend signaling causing UE 420 to return into the non-connected mode and continue with the positioning procedure during the idle or inactive state.

### Second Aspect

Embodiments of the second aspect of the present invention are now described with reference to FIG. 10. FIG. 10, like FIG. 9 schematically illustrate a part of a wireless communication including UE 420 in accordance with embodiments of the second aspect of the present invention. The UE 420 is to operate in a positioning session in the same way as described above with reference to FIG. 9.

In accordance with embodiments of the second aspect of the present invention, UE 420 is to perform measurements during a positioning session. It is assumed that the UE 420 performs the positioning measurements in a connected state when it was located at a location y, and for this location the LMF 422 provided UE 420 with the assistance data, AD(y), as is indicated at 432. Responsive to a suspend signal, like an RRC_Suspend signaling by the network, UE 420 moved from the connected state to the non-connected state, and also moved from location y to another location x. FIG. 10 illustrates a situation where UE 420 is at location x but holds still the assistance data 432 associated with location y. In accordance with embodiments of the third aspect of the present invention, in case UE 420 is not provided with AD for receiving DL-PRSs in the non-connected state before it receives the suspend command, the UE 420 continues to use the assistance data 432 provided for the positioning measurement in the connected state. In other words, in accordance with embodiments of the third aspect of the present invention, responsive to a transition from a connected state to a non-connected state, UE 420 treats the assistance data obtained for the connected state, as assistance data for the non-connected state.

UE 420 may associate the assistance data 432 with a default area validity indicating that the assistance data 432 originally valid only for location or area y is now also valid for a larger area covering also location x. Also a default expiration time may be associated with the assistance data which may be an expiration time which is extended when compared to an original time associated with the AD 432. The default area validity and the default expiration time may be parameters with which the UE is configured by the network. In case these parameters are not specified, the UE 420 may assume as a default area validity a cell-level, so that, for example, as long as the UE 420 moves within the same cell, the AD is considered still valid. In case no default expiration time is identified, the UE may assume the default expiration time to be the expiration time for system information, for example three hours.

### Third Aspect

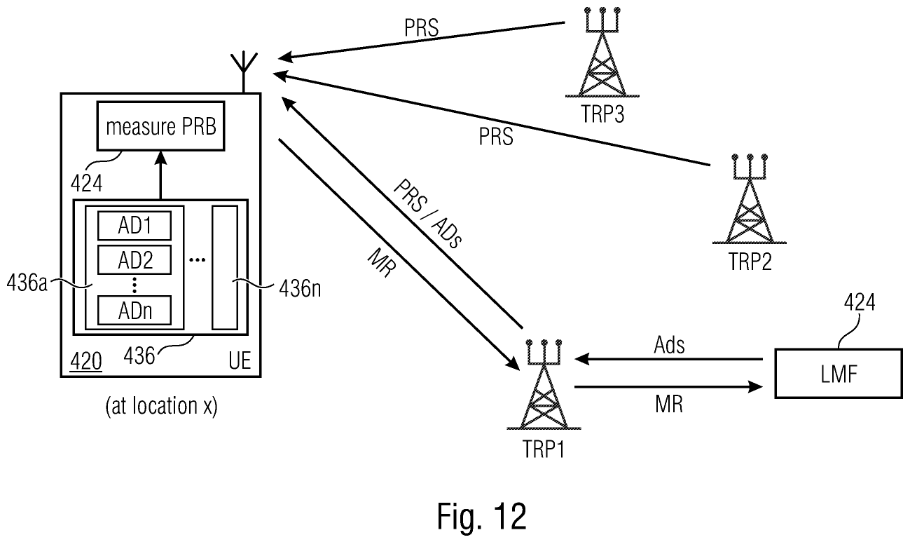

Embodiments of the third aspect of the present invention are now described. FIG. 11 schematically illustrates a part of a wireless communication system already described above with reference to FIG. 9 and to FIG. 10. The UE 420 is to operate in a positioning session in the same way as described above with reference to FIG. 9.

In accordance with embodiments of the third aspect of the present invention, the LMF 422 provides the AD to the UE 420. The UE may operate in the connected state or in the non-connected state, and the AD provided to the UE 420 covers the area or location x at which the UE is located when receiving the AD from the LMF, as is schematically indicated at 426a referring to AD(x). However, to cope with situations in which the UE changes to a location different from location x, either when being in the connected state or in the non-connected state, the AD provided by the LMF is extended, as is indicated schematically at 426b so as to cover an area larger than the area where the UE is located when receiving the AD.

For example, when considering a situation in which UE 420, after receiving the extended AD 426b enters into the non-connected mode, the UE may roam around the network area and apply cell-reselection while only sending periodic updates such as an RNA update or a TA update. While the network may know the cell where the UE was attached to, it may not always have knowledge about the actual location of the UE to a cell-level certainty when the UE is a non-connected mode. However, the embodiments of the third aspect address any problems with such a situation by providing the extended AD. In accordance with embodiments, the extended AD may be obtained by providing a higher number of one or more of the frequency layers, the TRPs per frequency layer, the resource set per TRP, the resources per resource set. In accordance with further embodiments, also an area or duration where the AD may be considered valid may be increased.

### Fourth Aspect

Embodiments of the fourth aspect of the present invention are now described with reference to FIG. 12. FIG. 12, like FIG. 9 to FIG. 11, illustrates a part of a wireless communication network schematically including the UE 420 in accordance with embodiments of the fifth aspect. UE 420 performs positioning measurements for a positioning session of the LMF 424.

In accordance with embodiments of the fourth aspect of the present invention, the UE 420 holds a set 436 of assistance data, as is schematically indicated by assistance data set 436a including AD1, AD2, . . . , ADn. The respective assistance data AD1 to ADn are also referred to as AD instance and are associated with different locations. When assuming that the UE 420 is located at a location x within the network area, for example, AD2 may be used for assisting with the measurement 424 of the PRBs. In case the UE 420 moves to a different location, like location y, another AD instance of the AD set 436a may be used for assisting with the measurement 424, for example AD1. Thus, in accordance with embodiments, the UE 420 may be configured with the assistance data set 436a where one or more instances of assistance data may be grouped together, wherein each of the AD instances may be in the form as described above with reference to FIG. 8, i.e. may include one or more of the indicated AD components.

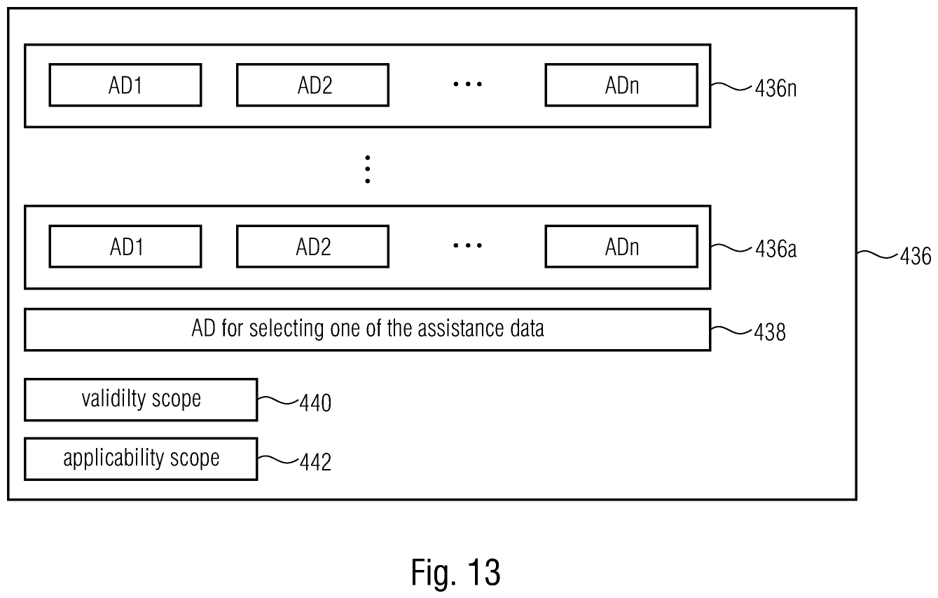

In accordance with further embodiments, UE 420 may include two or more AD sets, as is indicated schematically by the AD sets 436a to 436n. In other words, UE 420 may include a plurality of assistance data sets. FIG. 13, schematically, illustrates the assistance data 436 that may be provided for UE 420. In addition to the one or more AD sets 436a to 436n, further assistance data 438 for selecting one of the assistance data instance from 436a or 436n is provided together with a validity scope 440 and applicability scope 442.

It is noted that the embodiments of the fourth aspect of the present invention may be applicable both for the UE operating in the connected state and operating in the non-connected state or when the UE switches from one of the states to the other.

The fourth aspect allows, in accordance with embodiments, the UE 420 to determine hierarchically which of the assistance data instance provided to the UE is currently valid for assisting the positioning measurements. To allow for a selection of an appropriate assistance data instance from the AD set, in accordance with embodiments, the above-mentioned further assistance data 438 is provided on the basis of which a suitable AD instance that is applicable to the UE 420 at the current UE location or at the current UE location and at the current time may be selected. Different mechanisms for achieving this are described in more detail below.

In accordance with embodiments, the area where the assistance data is applicable may be indicated by an area identifier which may be part of the assistance data 402. The area identifier that corresponds to the current UE location and that is needed for selecting the appropriate assistance data instance may be signaled to the UE in unicast or it may be obtained by the UE from system information. In accordance with other embodiments, UE measurements on some reference signals, for example a cell re-selection measurement, allow the UE to determine its location and associate this determined location within the network to an area identifier associated with the assistance data thereby allowing the UE to select the appropriate one of the assistance data instance from an AD set.

In accordance with further embodiments, as mentioned above, the assistance data set 436 may be configured with the validity scope 440 for indicating at least an area within a notification area where the AD is applicable. Further, the validity scope may indicate whether the AD has one of the following validity states: active, deactivated, expired or invalid. In case this field is not present, the assistance data set 436 may be assumed to be applicable until a new AD set is provided for the UE 420.

Further, the UE 420 may be provided with the applicability scope 442 that specifies under which conditions the assistance data may be applicable, for example, it may specify that the assistance data is applicable for UE-assisted, UE-based, RRC_INACTIVE, RRC_CONNECTED, RRC_IDLE positioning sessions or combinations thereof.

In accordance with further embodiments, in case a plurality of AD sets 436a to 436n are employed, the validity scope and/or the applicability scope may also indicate whether a certain AD set among the plurality of AD sets is valid and under which conditions it is applicable.

### General

It is noted that the above-described embodiments concerning the first to fourth aspects of the present invention may be used individually or may be implemented in such a way that one of more or all of the first to fourth aspects are combined.

Further embodiments pertaining to all of the above-described aspects are now described in more detail.

### Area Identifier

As mentioned above, an area identifier may be associated with the assistance data to allow determining whether assistance data is valid for a certain area or location where the UE is currently located. This applies for all of the assistance data mentioned above in the respective aspects.

The notification area where the UE may be reached within a network, like the RAN notification area for RRC_INACTIVE mode or the tracking area for the RRC_IDLE mode, may be sub-divided into smaller areas, which, in turn, may be further sub-divided. Such a sub-divided area is identified by the so-called area identifier, which the LMF may associate uniquely with a certain physical area or a certain logical area within the notification area. A UE location may be identified using the area identifier or using a different identifier dependent on the granularity of the resolution of a UE location. An area that is identified by an area identifier may be part of an area also identified by another identifier of a different hierarchy.

Likewise, assistance data or part of the assistance data may be associated with an area identifier indicating the AD's applicability with regard to an area in which the UE is currently located. For example, when the UE location is identified by an area identifier, and when this identifier matches the area identifier associated with an AD, the AD stored by the UE has an area validity for the current UE location. In other words, the assistance data having an area identifier matching the area where the UE is located, may be validly used by the UE for assisting the UE's positioning measurements.

A region covered by an AD or an AD instance may be indicated by specifying a spatial region of validity. The spatial region of validity may be one or more of the following:
the RAN notification area and/or the tracking area,
the system information area,
the positioning system information area,
the cell,
a certain part or portion of a cell, or a certain part or portion of the RAN notification area, or a part or a certain portion of the system information area or a part or a portion of the positioning system information area, each being denoted by an appropriate area identifier,
certain parts or portions of at least two cells,
any combination of the above areas.

Within a set of assistance data or within an assistance data instance, some AD components may be applicable to areas that are wider than areas associated with other AD components. Also, such components may be applicable to multiple UEs. For example, the AD component 402 described above with reference to FIG. 8, i.e., the AD concerning the DL-PRS, may have an applicability area that corresponds to the positioning system information area, i.e., the configured downlink reference signals are applicable to the entire area associated with the positioning procedure. On the other hand, the AD 404 for selecting a subset of DL-PRS signals for measurements, as indicated, for example, in the IE NR-SelectionDL-PRS-IndexList, may have an applicability area of only a certain part of a cell. This applies both for assistance data for assisting the UE operating in the connected state or in the non-connected state.

When considering the fourth aspect of the present invention, the respective AD instances indicated in the respective AD sets 436a to 436n (see FIG. 13) may have a validity scope corresponding to the positioning system information area, i.e. each of AD1 to ADn may be applied in the overall system information area, however, different AD sets may have different AD instances and the different AD sets may have a validity scope corresponding to the notification area.

### Validity Information of the AD

In accordance with further embodiments of the present invention, an AD provided to the UE may be associated with a plurality of validity states. The AD provided to and stored by the UE may have two validity criteria, namely a spatial validity, i.e., an area to which the AD is associated matches the current area where the UE is located, and a temporal validity, i.e. a time since providing the AD to the UE is within a predefined time period beyond which the assistance data expires, also referred to as validity time. Dependent on which of the criteria is fulfilled, assistance data stored by the UE, like UE 420, may be assigned one of the following states: active, deactivated, expired, invalid.

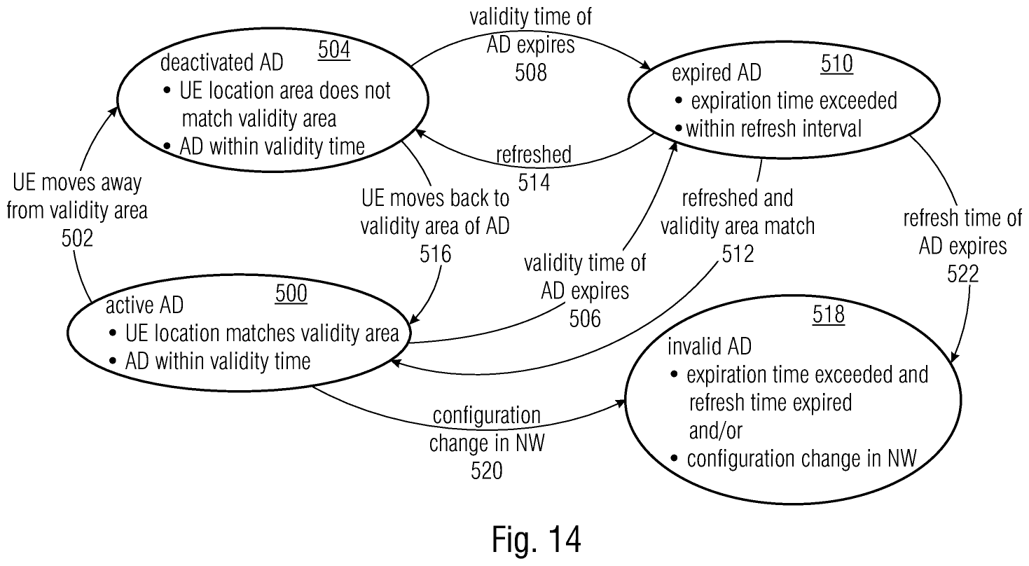

FIG. 14 illustrates an embodiment for the just-mentioned validity states and the respective transitions between the states. For an AD having an active state 500, an area identifier, for example, computed by the UE or provided by the UE by the network, matches the validity area for the assistance data, and, in addition, a time elapsed since acquiring the assisting data is within the validity time. In case the UE 420 moves away from the validity area, as is indicated at 502 in FIG. 14, the area identifier computed by the UE or provided to the UE by the network no longer matches the validity area for the assistance data, however, in case the time elapsed since acquiring the assistance data is still within the validity time, the assistance data is associated with the state deactivated 504. In case the validity time of an AD being active or deactivated expires, as is indicated at 506 and 508 in FIG. 14, the state of the AD is changed to expired 510.

In accordance with embodiments, a refresh period or interval may be configured at the UE 420, and the UE 420 may store the assistance data, provided it has the capability to do so. In case a signaling indicative of a continued validity of the AD is received within the refresh interval, which is also referred to as a refresh signaling, the state of the AD returns to the active state in case of the area identifier for the UE matching the validity area of the assistance area, as is indicated at 512, or the state transitions to the deactivated state in case no validity area match is given, as is indicated at 514.

In case the AD is in the deactivated state, but the UE moves back to the validity area of the AD, as is indicated at 516, the state of the AD transitions from the deactivated state 504 to the active state 500.

In case the AD is in the active state 500 and a configuration change in the network is detected, the AD transitions to the invalid state 518. Likewise, the state of the AD transitions from the expired state 510 to the invalid state 518 once the refresh time associated with the AD expired. In accordance with embodiments, assistance data being in the invalid state 518 may be safely deleted by the UE 420.

The above-described validity states associated with the assistance data and the transitions among the validity states may depend on the UE. In other words, the validity states that are supported by the UE may be signaled by the UE capability. In accordance with embodiments, the UE capability indicates whether an expired AD is stored by the UE and, if yes, how long the AD is stored. The capability may be shared across frequency layers, bands, frequency ranges or may be specified individually. In accordance with embodiments, a UE that signals its capability to perform positioning measurements, for example in the connected state or in the non-connected state, may signal also one or more of the following:
The UE supports validity states for the ADs, e.g., the UE may signal that it stores only an active AD, or active and deactivated ADs, or expired ADs.
The UE has the capability to store assistance data not corresponding to a current validity area, e.g., subject to its capability, the UE may signal a number of assistance data and/or a duration how long it may store or hold the assistance data. The capability may be expressed as the number of TRPs that a UE may store or the capability may be expressed as the number of instances (e.g. at the maximum size per instance) that the UE may store.
The UE has the capability to store expired assistance data, e.g., subject to its capability, the UE may signal a number of expired assistance data and/or a duration or time how long it may store or hold the expired assistance data, e.g., the UE may signal a duration of the refresh interval.

### Mechanism to Select an Assistance Data Component

In accordance with embodiments of the above-described aspects, the UE, like 420, may be signaled to select one of the AD components from an AD instance, for example in case of embodiments of the first to third aspects, or to select an AD instance from AD set, for example in case of embodiments of the fourth aspect, as the active assistance data. In addition, the applicability of the active assistance data with regard to different RRC states and different positioning modes, like UE-assisted or UE-based, may be indicated. The signaling may be provided as a part of the positioning system information, like the posSIB, or it may be sent to the UE in a unicast mode or it may be relayed via another network component.

In accordance with other embodiments, rather than selecting assistance data by signaling a selection, the selection may be performed by a measurement that is associated with a certain assistance data component or assistance data instance. The UE 420 may be provided with a configuration that maps certain UE measurements and/or certain parts of the system information that the UE may have acquired, to a selection of the assistance data component or the assistance data instance from the AD set. In accordance with such an embodiment, the AD components may be associated with an area indicated by an area identifier, as described above, and the UE may obtain an identifier of the area where it is located by reading the system information or by determining the cell where the UE is camped. By comparing the area indicated by the area identifier of the AD component or the AD instance, and the area indicated by the area identifier of the UE location, the UE 420 may determine whether the assistance data component or the assistance data instance is to be marked as an active AD or not. For example, the UE 420 may be configured to measure the Reference Signal Received Power, RSRP, respective SS/PBCH (Synchronization Signal/Physical Broadcast CHannel) blocks, like on SSB_1, SSB_2 and SSB_3. The measurement may, for example, be part of a measurement needed for a cell-reselection when the UE is in a non-connected state. The measurement outcome on the respective SSBs may be as shown in the following table 1.

| Measurement | | | |
|---|---|---|---|
| Outcome | SSB_1 | SSB_2 | SSB_3 |
| RSRP < −130 | 1 | 0 | 0 |
| −130 < | 0 | 1 | 0 |
| RSRP ≤ −110 | | | |
| −110 < | 0 | 0 | 1 |
| RSRP ≤ −80 | | | |
| RSRP > −80 | 0 | 0 | 0 |

The different levels of RSRP experienced by the cell on the respective SSBs, allows associating the UE to a rough area, so that the outcome or result of the measurement may be associated with a particular assistance data component or assistance data instance, as is illustrated in the following table 2.

| | Selected AD |
|---|---|
| | Component |
| Outcome form | from 400 or AD |
| Measurement | instance from 436 |
| 100001000010 | 300a |
| 010001000010 | 300b |
| 000100010010 | 300c |
| 001000010001 | 300d |

In table 1, there are indicated the measurements on SSB_1, SSB_2 and SSB_3 and some conditions to check for. The outcome of the conditions, which is used as an identifier to denote the outcome, are mapped to an area. For example, the outcome of the measurement may be events like:
Measurement Outcome: The RSRP of the SSB_1 is less than −130 dB, but SSB_2 is between −130 dB and −110 dB and SSB_3 is between −110 dB and −80 dB. This condition is fulfilled when a user is in a certain area, for example in a certain region close to the TRP transmitting SSB_3. This particular condition is denoted by an eventID, like here 100001000010 in table 2.

A set of such measurements and their mapping to area may be provided to the UE, and then the outcome is mapped to an area, like Area 300a in table 2. In accordance with other embodiments, the measurement conditions may be mapped directly to an area.

In accordance with other embodiments, the UE may use certain measurements on downlink reference signals, DL-RS, and use the measurements to determine an area identifier associated with the UE, and/or determine which of the AD components or AD instances is to be considered active. For example, the NR Cell Global Identifier, NCGI, of the cell on which the UE camps may be taken as an identifier of the area associated with the UE which may be translated into the Physical Cell Identifier, PCI, so that the mapping of the area associated with the UE to the AD instance may be as in the following table.

| | Selected AD |
|---|---|
| | Component from |
| | 400 or AD |
| PCI | instance from 436 |
| 0001 | 300a |
| 0002 | 300b |
| 0003 | 300c |
| 0004 | 300d |

Likewise, in the above example, the measurement may be made on a certain DL-RS such as a DL-PRS, and the outcome of the measurement on one or more DL-PRSs may be used to map to an area and/or to a measurement outcome. A certain instance of an AD and/or a certain component of AD from an AD set and/or a certain component of AD from an AD instance may be used as an applicable AD based on such measurement.

In the following, embodiments for the assistance data used for the positioning measurement are described in more detail.

### AD Regarding the Configuration of DL Reference Signals (See 402 in FIG. 8)

In accordance with embodiments, the assistance data component 402 may comprise the IE NR-DL-PRS-AssistanceData described above with reference to FIG. 6, which is an example for a possible configuration of the downlink reference signals that may be used by the UE for the positioning measurements when the UE is in the RRC core connected state. For the RRC_INACTIVE or RRC_IDLE state, the assistance data regarding the configuration of the DL reference signals may be an equivalent IE, that is denoted as NR-DL-PRS-AssistanceDataInactive, wherein the assistance data for indicating or signaling the configuration of the DL-PRS to be used when the UE is in a non-connected mode, may be different from the IE used for the connected state.

In accordance with embodiments, for the non-connected state, the IE may have a hierarchy that is different from the one in the IE for the connected-state, i.e., the hierarchy may be different than frequency layer, TRP, resource set and resources. In accordance with other embodiments, instead of the different hierarchy or in addition thereto, a larger number of elements may be indicated, like a larger number of TRPs, for example more than 64 TRPs, that the UE may encounter within the notification area. In accordance with embodiments, a maximum size of the NR-DL-PRS-AssistanceDataInactive that the UE may store depends on the UE capability. The UE capability may be transferred by the UE to the LMF, for example unsolicited or in response to the provide capability request from the LMF, and the LMF, responsive to the signal capability, may determine the maximum size and, thereby, for example the maximum number of TRPs, to be included into the IE.

In accordance with the just-described embodiments, when considering, for example, the embodiments of the fourth aspect of the present invention, the AD set 436 may include an AD instance only having the AD component 402 which is represented by IE NR-DL-PRS-AssistanceData and that is valid for the RRC_CONNECTED state, as well as a further AD instance including only AD component 402 in the form of the above-mentioned IE NR-DL-PRS-AssistanceDataInactive to be used or valid for the RRC_INACTIVE state or the RRC_IDLE state.

In accordance with other embodiments, an AD instance may include, in addition to the AD regarding the configuration of DL reference signals in the form of the NR-DL-PRS-AssistanceData or in the form of an NR-DL-PRS-AssistanceDataInactive, as described above, one or more of the further AD components 404 to 410 described above with reference to FIG. 8.

### Selection of the DL-PRS-Signal for the UE to Measure for a Given Method

In accordance with embodiments, AD 404 for selecting a subset of DL-PRS signals may include a list including resources that are indicated, for example in the NR-DL-PRS-AssistanceData described above with reference to FIG. 6 and/or in the AD components 402. The listed resources are the DL-PRS that are to be measured. The list may be signaled by an IE named NR-SelectDL-PRS-IndexList for a positioning session in the RRC_CONNECTED state. This IE may be signaled to the UE within the above-described IEs concerning TDOA, AoD and Multi-RTT, for example in the IEs NR-DL-TDOA-ProvideAssistanceData, NR-DL-AoD-ProvideAssistanceData or NR-Multi-RAT-ProvideAssistanceData (see FIG. 5) for selecting the resources to be measured from the assistance data.

For measurements in the non-connected mode, the UE may receive a corresponding list, which may be referred to as NR-Select DL-PRS-IndexListInactive. In accordance with embodiments, this list may be received by the UE each time the network determines that different resources need to be selected by the UE for a given method. The signal may be provided as broadcast message, common to all UEs. In accordance with other embodiments, the UE may be paged, transition to the connected state to receive the message followed by the reception of an RRC_Suspend message. Alternatively, the UE may receive the transmission using small data transmission without entering the RRC_CONNECTED state. Likewise, when operating in the connected state, the UE may receive a new list for the non-connected state whenever the network determines the need of different resources.

In accordance with other embodiments, the UE may be preconfigured with several sets of the lists, both for the connected and non-connected states, from which the UE may select the DL-PRS to be measured for the respective methods. The network may signal to the UE which list is to be used, for example in the same way as described above by paging the UE and transmitting an index either with or without the UE transitioning into the RRC_CONNECTED state.

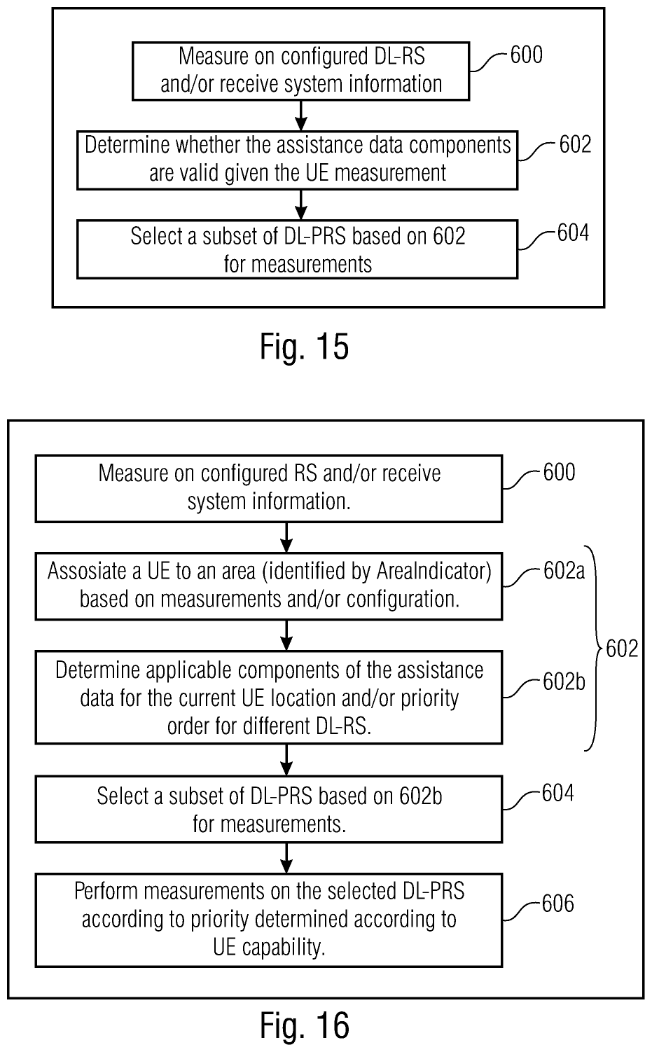

In accordance with yet further embodiments, the UE may determine the DL-PRS to measure based on system information or measurement. FIG. 15 illustrates an embodiment for determining the DL-PRS to be measured by a UE illustrates an embodiment for determining the DL-PRS to be measured by a UE for the positioning measurements based on system information and measurement. The UE may be configured to perform measurements on certain downlink signals, as is indicated at 600, and the measurement may be part of RRM measurements cell-reselection, for example during the idle/inactive state. Based on the measurement, as is indicated at 602, the UE determines which assistance data components or which assistance data instances are valid in view of the UE measurement and, at 604 selects a subset of DL-PRS for the measurements.

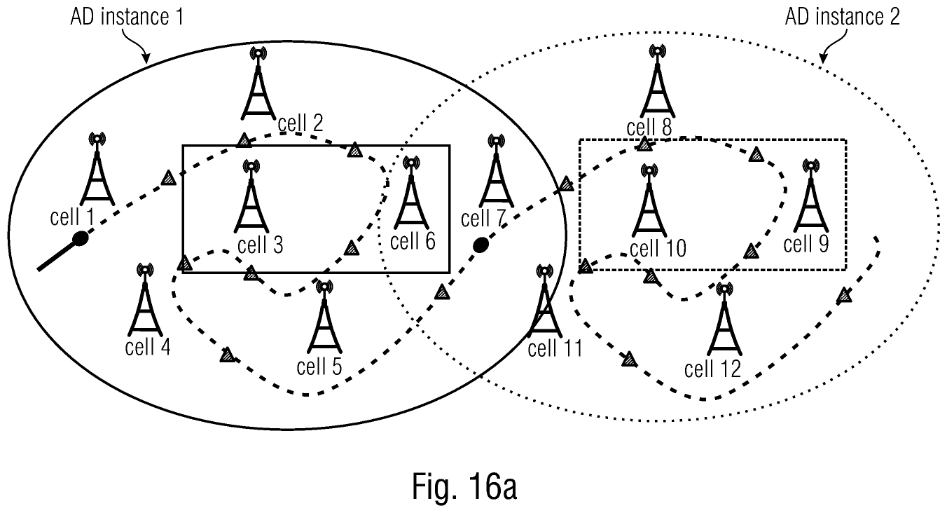

In accordance with further embodiments for determining the DL-PRS to perform the positioning measurement, which is illustrated in FIG. 16, step 602 includes the substeps 602a and 602b. In step 602a the UE receives a configuration for associating the measurements performed at 600 to an area, which may be identified by an area indicator. In accordance with other embodiments, the UE may receive system information from the camped cell from the UE may detect the area where the UE is located. In step 602b the UE determines which of the configuration of DL-PRS reference signals is applicable for the UE at the identified area and, optionally, determines a plurality order for measuring the reference signals. At 606 the UE performs the DL positioning measurement on the selected DL-PRS resources based on the priority, if determined.

### AD for Determining the Priority of DL-PRS Signal to Measure (See AD 406 in FIG. 8)

The assistance data for determining the priority may include priority information for determining the DL-PRS to be measured. The information about the priority may be in the form of the list and may be provided as unicast data and may refer to the AD component 402, i.e. may indicate a priority list associated with the DL reference signals indicated in AD 402. In accordance with embodiments, the priority list may be determined using a measurement on downlink reference signals, like measurements on the SSB the UE is configured to measure for mobility management. The measurement obtained may be used to determine the priority of the DL-PRS measurements.

In accordance with the embodiments, two or more instances of AD may have some TRPs in common. The two assistance data may however differ in the order of priority in which the TRPs that are common in two AD instances may be measured. In an example scenario, depicted in FIG. 8a, a UE is provided two AD instances, AD instance 1 and AD instance 2.

The circles enclose the TRPs whose AD is contained in the respective instances, and the rectangles enclose the cells where the respective AD instance is applicable. In this example, the AD instance 1 is applicable when the UE is camped within either cell 3 or cell 6, whereas the AD instance 2 is applicable when the UE is camped within cell 10 or cell 9. When the UE is camped within other cells, the UE may have been provided other AD instances with their respective applicability areas, which are not depicted here for clarity. It can be observed that cell 6 and cell 7 are both contained in AD instance 1 and AD instance 2. However, when the UE is camped within either cell 3 or cell 6, the UE may be configured to measure cell 6 with higher priority than cell 7. By contrast, when the UE is camped within cell 10 or cell 9, the UE may be configured to measure cell 7 with higher priority than cell 6. One of the reasons why priority may be assigned could be to receive signals from stronger cells, while maintaining a good geometric dilution of precision, GDOP, as also depicted in the earlier example. In general, the reasons for assigning a TRP a higher priority than another for a given location may be a network operation policy of the operator.

### Broadcasting Assistance Data for Measurements of Positioning Reference Signals

In accordance with embodiments, additional positioning system information block types, posSIB types, are provided for transmitting AD to be utilized by one or more UEs in the network. For example, for a UE being in non-connected mode, the following information may be broadcast:
AD regarding the configuration of DL reference signals for a measurement,
AD for selecting a subset of DL-PRS signals for measurements corresponding to one or more positioning messages addressed to all UEs in the cell or to a group of UEs,
AD for configuring measurements and a configuration for mapping the measurements to the AD for the subset selection and/or to the AD for the DL-PRS resource selection,
AD for determining a priority of the DL-PRS signals to be measured,
AD for a measurement configuration and mapping of the measurement to a priority of the DL-PRS.

The broadcast data may further carry information like a validity area, for example indicated by the area indicator, a validity time and an AD version.

In accordance with embodiments, responsive to a change in an AD version, the network may page the UE to update the posSIBs. For example, the version of the AD components which are currently valid in an area may be broadcast in a posSIB. The changed AD is only broadcast in the cells where the AD is broadcast.

In case the UE receives the AD component or the AD instance via broadcast, the UE may check a version of the AD before the validity time of the AD expires. In case the version broadcast from the network matches a version stored at the UE, even after the validity time has expired, the AD is considered to be refreshed and the AD status may be moved from expired to active or deactivated (see FIG. 14 above).

Furthermore, a UE may be signaled by the network to release a part or all of the AD stored by the UE.

### Maintaining Assistance Data

Dependent on the positioning procedure mode, the assistance data may be maintained in different ways.

In case the positioning procedure operates in UE-assisted mode, the LMF knows the location of the UE during the last reporting period. If the LMF determines that any AD component previously provided to the UE needs to be updated, the LMF may page the UE
(i) to provide the updated assistance data to the UE, or
(ii) to send the assistance data in an LPP message to the gNB hosting the cell from where the UE last sent location information, like UE measurements, either in the connected or in the non-connected state, or the cell where the UE initiated an RAN updated procedure.

The LMF may initiate the session for any reason the assistance data needs to be changed, which may include a network reconfiguration or due to a change in the quality of the measurement results.

In case the positioning procedure operates in a UE-based mode, the UE may send an assistance data request to the LMF if it determines that the AD provided to it, for example, in a unicast mode, is not suitable for determining a position. The UE may send the area identifier where the UE is currently located so that the LMF may provide updated assistance data to the UE. In broadcast mode, the UE may check the version of the received assistance data to determine if the version is suitable. In accordance with embodiments, the UE may report the UE position using provide location information so that the LMF may determine if the position and the assistance data are suitable for positioning with the required Quality of Service, QoS, and, if not, the LMF may cause an update of the assistance data.

In case the UE moves outside the notification area, the UE may discard all assistance data and try to acquire a new positioning configuration broadcast from the camped cell. The UE may initiate an RNA update or a Tracking Area Code, TAC, update. In case the UE is not able to acquire any positioning configuration from a broadcast, the UE may send a request assistance data indicating the new RNA or TAC area.

### Combining Assistance Data Received by UE via Unicast and Broadcast

In accordance with embodiments, the UE may receive assistance data via unicast, multicast, groupcast or broadcast messages. In accordance with embodiments, in case the UE receives the same information for assistance data from a unicast message and from any other of the messages, the assistance data received in the unicast message is assigned a higher priority than the assistance data received on another one of the multicast, broadcast or groupcast messages. In case certain fields are missing in the broadcast, but are provided by the unicast, the information from the broadcast and unicast may be combined.

In accordance with embodiments, when the assistance data transmitted via the broadcast changed, and the unicast AD is not associated with any expiration time, the IEs from the unicast message may be used together with the IEs from the previous broadcast and together with the IEs from the new broadcast. In case a combination of the broadcast and the unicast causes inconsistent configurations, the UE may drop the merged information and use the previously provided information.

In accordance with further embodiments, the UE may benefit from a UE-specific assistance data for some IEs but may use also data from the broadcast for other IEs for the same current IE. In such a scenario, the LMF may signal the UE to update certain fields using unicast signaling, and the update mechanism may apply to assistance data provided for positioning in anyone of the connected state and non-connected state.

For example, the fields that may be updated using unicast signaling include expected Reference Signal Time Difference, expectedRSTD, and nr-DL-PRS-ExpectedRSTD-Uncertainty that may defined within the IE NR-DL-PRS-AssistanceData per TRP. The parameters may be present or absent in the broadcast mode, however, in the unicast mode, the UE may be configured with the expected RSTD and the expected RSTD uncertainty taken into account the RTD and the rough location of the UE, obtained, for example, by using E-CID measurements. Broadcasting such information or values causes a common value to be provided to all UEs which does not help the UE to find a reference signal with a narrow window where it is supposed to measure the signal. To address this scenario, the IE may either be omitted in the broadcast, in case it is not mandatory for the UE, or the parameter may still be broadcast but a unicast message to the UE overrides the IEs from the broadcast. For example, a message “overwrite broadcast assistance data” may be provided which includes the information about fields of posSIB type that are to be overwritten as well as the value in the field that needs to be overwritten. Additionally, it may provide the area identifier where the UE might have acquired the broadcast information. As an example, the expectedRSTD, and nr-DL-PRS-ExpectedRSTD-Uncertainty may be corrected for a particular UE assistance data by specifying a particular frequency layer, a particular TRP, a particular resource set and a particular resource by indicating the identifiers for each of the levels and signaling a new value associated with the fields.

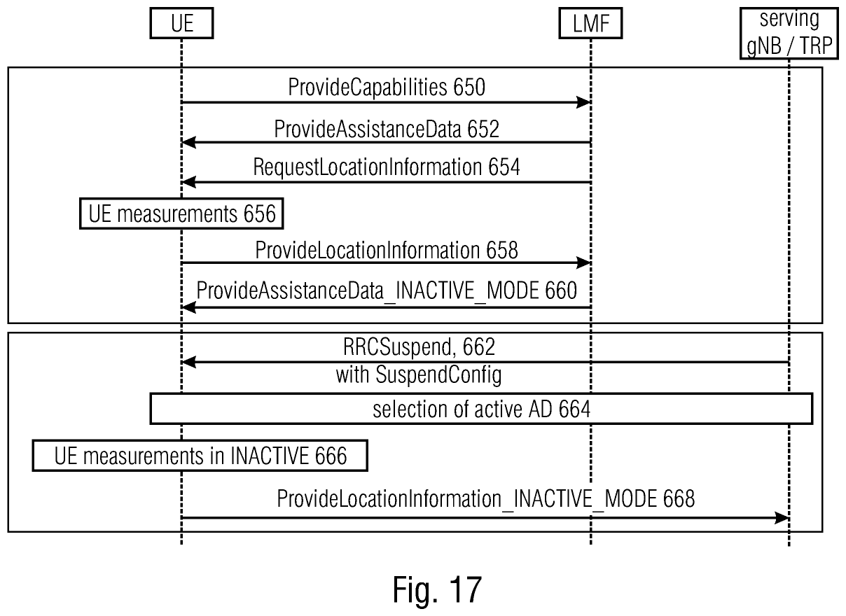

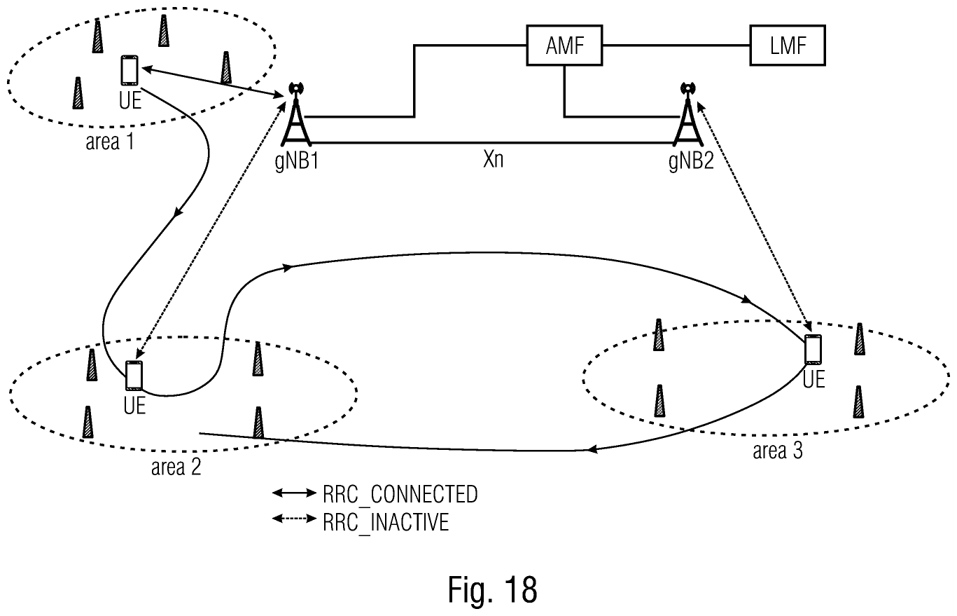

With reference to FIG. 17 and FIG. 18, an embodiment for an RRC_INACTIVE procedure in a cellular network is described. FIG. 17 illustrates the call flow for a UE positioning measurement during an RRC_INACTIVE state, while FIG. 18 illustrates the RRC positioning in the inactive state. The UE has data and signal connectivity via either gNB₁ or gNB₂ in FIG. 18, and there are three different areas where the UE sees a higher density of TRPs than elsewhere, namely area 1, area 2 and area 3. When a positioning session for the UE is initiated at the LMF (see FIG. 17), the LPP session between the LMF and the UE is initiated. As is indicated at 650 in FIG. 17, the UE provides its positioning capabilities to the LMF. For example, the UE may signal whether it supports positioning in RRC_INACTIVE state or RRC_IDLE state, its ability to receive positioning assistance data via broadcast and unicast and its capacity to store inactivated and expired data, as explained above. Responsive to the signaling of the UE capabilities, the LMF delivers the assistance data applicable for the RRC_CONNECTED mode, as is illustrated by the message provide assistance data 652. By means of the request location information message 654, the UE is requested to report positing measurements to the LMF. At 256, the UE performs the positioning measurements of DL-PRSS provided in the provide assistance data using selected PRS index, subject to the priority order and the UE capability and reports to the LMF the measurement using the provide location information message 658. The LMF provides to UE the ProvideAssistanceDataInactive mode message 660 including assistance data for the non-connected state, for example, via a unicast transmission. The UE may access this data also using information from a posSIB that is broadcast by the LMF. In the depicted embodiment, it is assumed that the assistance data is structured hierarchically and that, in accordance with embodiments of the fourth aspect of the present invention, contains an AD set as described above with reference to FIG. 12. The AD instance are hierarchically structured with different area indicators, for example, in such a way that the AD instance AD1 is associated with area 1, AD2 is associated with area 2 and AD3 is associated with area 3. At 662, the UE receives the RRC_Suspend from gNB₁ thereby allowing the UE to camp anywhere within the RNA served by gNB₁ and gNB₂, which may be indicated by a suspend configuration.

The UE, now being in non-connected mode, may select a set of assistance data based on measurements of the RSRP. Based on the RSRP, the UE may detect that it is in area 1, and marks this area as active assistance data. The UE may have received the above-described NR-selected-DL-PRS-IndexListIdle that is applicable to this area as unicast message and selects the DL-resources to measure from this list. If a priority is specified, the UE makes the measurement in accordance with the specified priority, as is indicated at 668. At 668, the UE reports the location, for example, during a paging occasion without transitioning into the connected state for reporting the measurement in idle mode.

The above process described with reference to FIG. 17 assumes UE to be in area 1 of FIG. 18. As the UE moves in the RNA, which is the RNA served by gNB₁ and gNB₂, and goes inside area 2 while still camping on gNB, the UE determines that now assistance data AD2 is valid. It marks the assistance data AD1 associated with area 1 as deactivated assistance data as described above with reference to FIG. 14. In accordance with the embodiment depicted in FIG. 17 and FIG. 18, it is assumed that the UE does not have a configured list of resources to be measured in area 2, but that the assistance data provides measurement rules on the basis of which the UE determines which of the DL-PRS it needs to measure, for example, based on RSRP measured on certain reference signals as also described in more detail above. The UE may report the measurements in the same way as described above without going into the connected state.

In case the UE moves further along the path indicated in FIG. 18 and performs cell- reselection and camps on a cell hosted by gNB₂, in this area, the indication of the active AD, the selection of DL-PRS resources and the priority may be indicated by posSIBs. The UE deactivates the AD instance AD2 and marks AD instance AD3 as an active AD. When the UE returns back to area 2, it finds out that AD2 stored by UE may still be valid in time and moves AD2 back to the active state while moving the assistance data for area 3 into the deactivated state.

The UE, in accordance with embodiments, may inform the LMF that it has been moved into the non-connected state, or the LMF may infer this from the reporting of the DL-PRS resources. According to an embodiment, when transmitting the measurement results using small data transmissions, the UE may drop some measurements, such as additional path measurements and additional further measurements if the UE is transmitting an LPP message containing the measurement to the LMF in the non-connected state. In case the accuracy and/or latency requirements for positioning may not be met by the UE positioning process in the non-connected state, the LMF may request a change of the RRC state. Likewise, the LMF may run a tracking mode and may require occasionally high accuracy measurements for updating, which also causes a request for the UE to change to the connected state. According to an embodiment, the NG-RAN node, when receiving a request from the LMF to transit the UE to the connected state, may instigate a paging procedure to the UE to initiate a positioning procedure in the RRC_CONNECTED state.

In the following, embodiments for signaling assistance data are described.

In accordance with embodiments, as also described above, the UE may be provided with the assistance data for use in IDLE mode when the network, NW decides to send the data to the UE or when the UE requests new set of assistance data. The data may be delivered while the UE is still in the RRC_CONNECTED state. This may be provided as unicast data or as a broadcast data from the serving cell. If the data is not delivered when the UE is in RRC_CONNECTED mode, then, if the UE supports positioning in idle, the UE shall receive the assistance data in from the positioning SIB broadcasted in the camped cell. Alternatively, the UE may acquire the assistance data using an on-demand transmission of system information. Alternatively, if the AD has changed, the UE may be paged and the UE switches to RRC_CONNECTED state to receive an updated assistance data before it is sent back to the RRC_INACTIVE state. Alternatively, the UE may also request an updated assistance data, if it determines that it needs an updated AD according to some specified criteria.

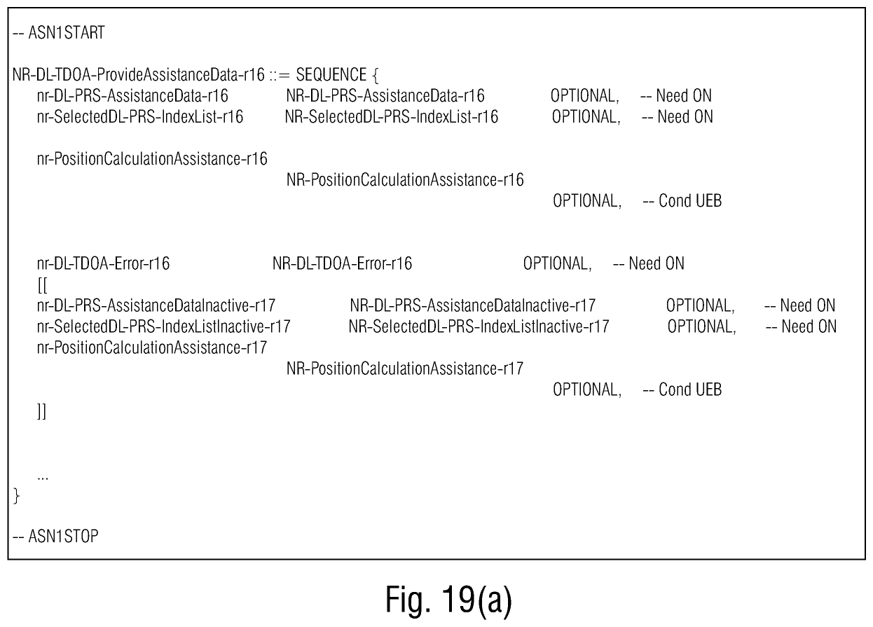

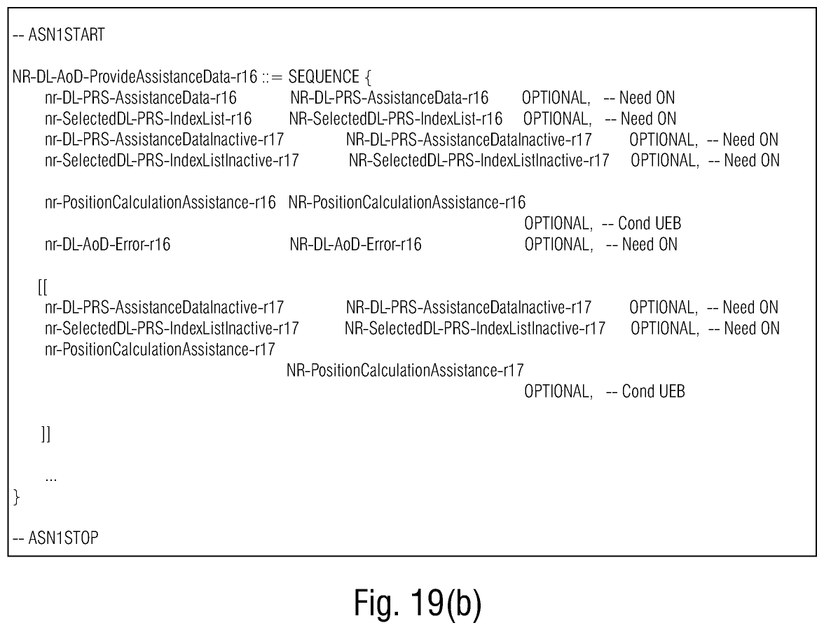

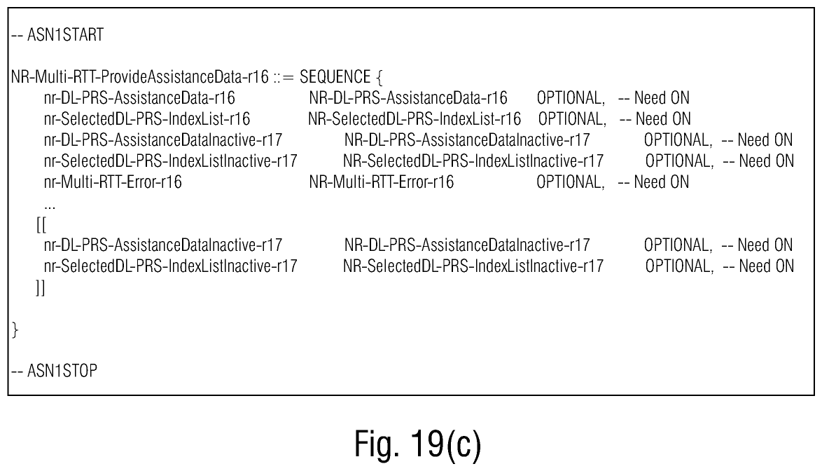

In accordance with embodiments, additional IEs are provided, and FIG. 19 illustrates the assistance data that is applicable to UE positioning in TDOA, AoD and Multi-RTT in Rel. 16 UE positioning of FIG. 5 including, in addition:
IE NR-PositionCalculationAssistance which provides assistance to the UE regarding the coordinates of the antenna reference points of the TRPs, spatial directions of the DL-PRS resources for the TRP and time synchronization information between the reference TRP and the neighbor TRP.

nr-trp-LocationInfo
This field provides the location coordinates
of the antenna reference points of the TRPs.
nr-dl-prs-BeamInfo
This field provides the spatial directions of
DL-PRS Resources for TRPs.
nr-rtd-Info
This field provides the time synchronization
information between the
reference TRP and neighbour TRPs.

IE NR-DL-PRS-AssistanceDataInactive-r17 which provides the AD for the inactive context. This contains AD for the UE to decode DL-PRS transmitted by different TRPs for measurement during the RRC_INACTIVE state. The assistance data spans frequency layer, TRPs, resource sets and resources. In one variant, the hierarchy of provided assistance data is frequency layer followed by TRPs, followed by resource set per TRP followed by resources. In another example, the hierarchy may begin with TRPs, followed by frequency layer, followed by resource sets per TRP and followed by resources within the resource set.
IE nr-SelectedDL-PRS-IndexListInactive-r17 above.

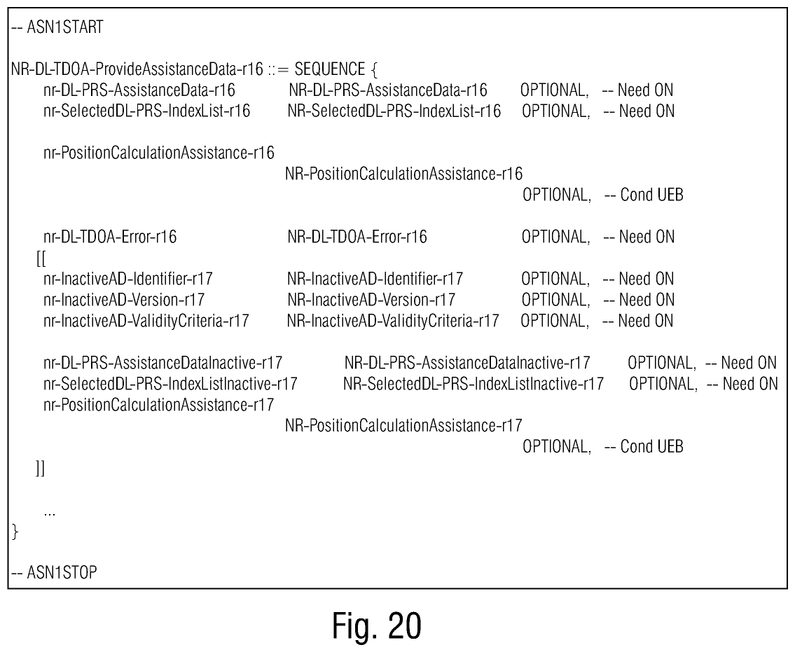

In accordance with the described embodiments, the assistance data delivered to the UE may additionally contain information regarding the AD identifier and/or version and/or validity criteria. The AD identifier is used by the UE to refer to a particular set of assistance data, the version refers to an identifier and/or a numerical value that is incremented when some information in the assistance data changes and the validity criteria may specify in which area is the inactive data valid and for how long. In accordance with embodiments, additional IEs are provided, and FIG. 20 illustrates the assistance data that is applicable to UE positioning in TDOA in Rel. 16 UE positioning of FIG. 5(a) including, in addition (it is noted that the same IEs may be added to the assistance data in FIG. 5(b) and FIG. 5(c)):
nr-InactiveAD-Identifier-r17
nr-InactiveAD-Version-r17
nr-InactiveAD-ValidityCriteria-r17

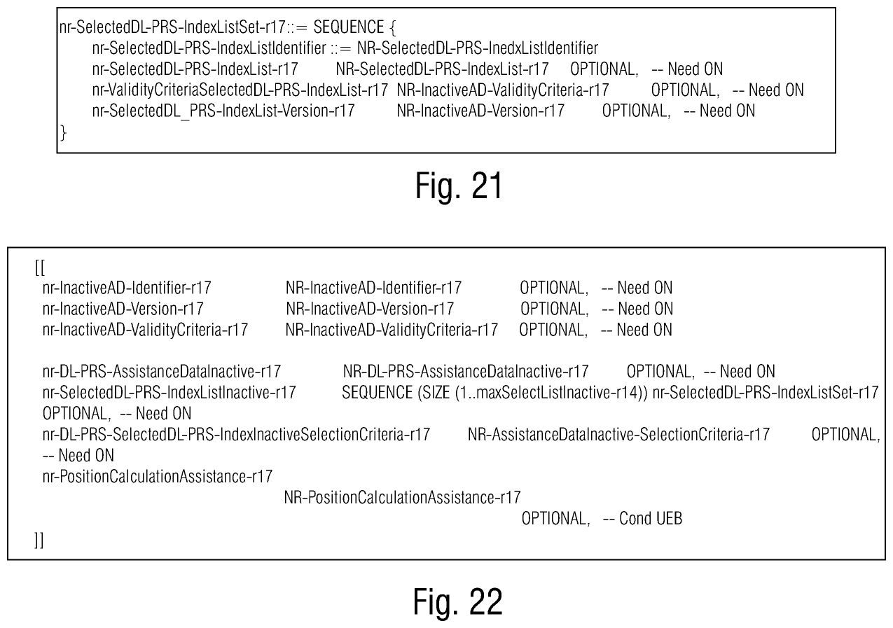

In accordance with further embodiments, a UE may be configured with multiple instances of the nr-SelectedDL-PRS-IndexListInactive-r17 to select the DL-PRS resources to measure. FIG. 21 illustrates an embodiment of providing information to define an instance nr-SelectedDL-PRS-IndexListInactive-r17, so that it may be selected from a set of multiple instances. The assistance data may then be structured as illustrated in FIG. 22.

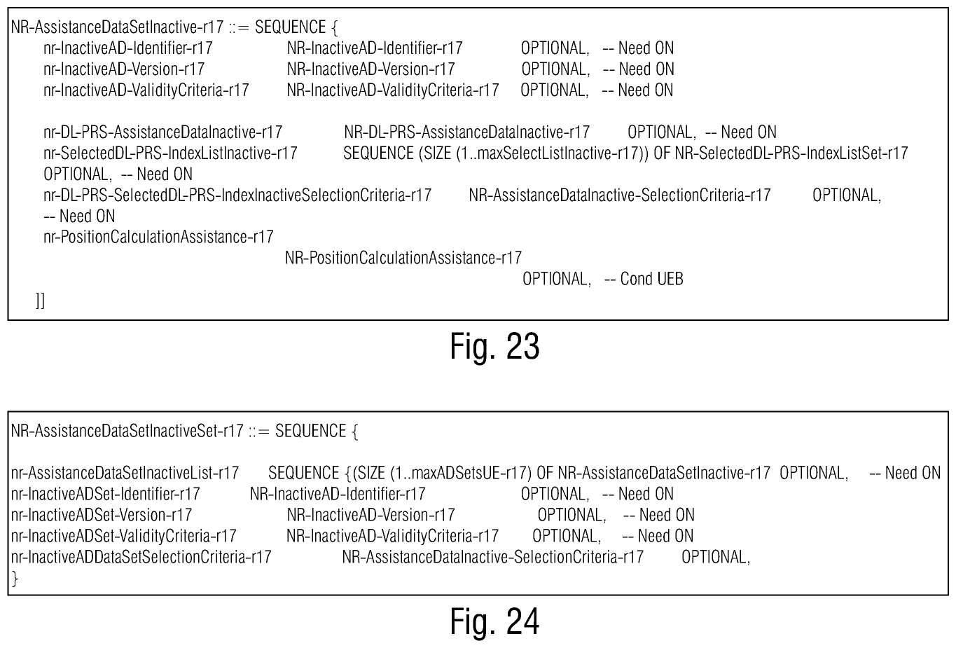

In accordance with further embodiments, a UE may be provided with two or more assistance data sets instead of single assistance data set. Then an element of assistance data sets may be defined as shown in FIG. 23 or in FIG. 24. For example, the respective assistance data sets may have a different structure/configuration information.

In accordance with further embodiments, NR-AssistanceDataSetInactiveSet-r17 may be further organized into a higher level IE that groups multiple instances of NR-AssistanceDataSetInactiveSet-r17 and specifies a corresponding identifier, version, validity criteria and criteria for selecting one of the NR-AssistanceDataSetInactiveSet-r17 from the set where this IE is grouped.

The hierarchy may correspond to an order in which a larger area is divided into smaller areas, which may either be overlapping or unique. For example, the tracking area may be divided into one or more RNA, the RNA may be divided into one or more system notification area. A system information area may be divided further into one or more positioning system information area. A positioning system information area may be further sub-divided into group of cells, a group of cells into cells, and a cell into area within a cell.

At each stage, the rules for selecting the AD corresponding to one layer down may be defined.

The updates may be provided by specifying one or more of the following: assistance data set identifier and version.

NR-AssistanceDataInactive-SelectionCriteria-r17 may be selection of an AreaIdentifier or MeasurementCriteria. The MeasurementCriteria may map the measurement the UE is configured to perform to a list of AD element selection. Alternatively, the MeasurementCriteria may map the measurement the UE made to an Arealdentifier. This AreaIdentifier may be used to downselect a set of AD from list of AD provided.

In accordance with an embodiment. The UE may be configured with a NR-AssistanceDataSetInactive corresponding to an area corresponding to the RAN notification area, which has multiple sets of NR-DL-PRS-AssistanceDataInactive-r17. An instance of NR-DL-PRS-AssistanceDataInactive-r17 may correspond to a positioning system area. A UE may detect either through measurement or via signaling (e.g. system information, unicast . . . ) that the UE is within a positioning system area. Then the assistance data for the positioning system area is active. From this set of AD, the UE may be configured with different sets of nr-SelectedDL-PRS-IndexListInactive-r17 to choose from. This may be based on measurement or configuration. For example, the UE may be configured to select one of the nr-SelectedDL-PRS-IndexListInactive based on the NCGI or PCI of the serving cell. In another example, the UE may be configured to perform some measurement (e.g. RSRP, RSTD, ToA, RTT) on some downlink signals (e.g. SSB or some DL-PRS or CSI-RS, etc.) and the outcome of measurement may map to an area, which in turn maps to a particular nr-SelectedDL-PRS-IndexListInactive. Alternatively, the outcome of measurement may map directly to an instance of nr-SelectedDL-PRS-IndexListInactive. Similarly, the priority may also be specified.

The assistance data at each level of hierarchy may be delivered by a combination of broadcast, unicast, groupcast or multicast. For example, at the positioning system information area level, the cells may indicate which set of assistance data are relevant to this system information area in the positioning system information level. The cell may then indicate the AD applicable to this cell and some nearby cells and provide an identifier to this assistance data. The nearby cells may similarly provide some AD applicable to the cell and some nearby cells. The UE may look at which information it already has, and which AD elements are missing and trigger AD request.

### Refresh

The NW may signal the UE to refresh an expired or an deactivated AD by indicating the identifier or repeating the complete assistance data. The identifier may indicate an area Identifier and a version.

The UE may confirm the receipt via SDT or may request the full AD to be delivered if it does not have the AD in the cache.

### Measurement Reporting

In inactive mode, the measurement or configuration may be used to select the reference TRP from the set of TRPs provided to the UE. In case of configuration, the cell may broadcast in the posSibs, the reference TRP to be used for measurement reportings. In case of determining by measurement, the reference TRP and/or reference resource and the priority of other TRPs and/or other resources may be chosen based on certain configuration mapping measurement on DL-RS to the reference TRP.

In the embodiments described herein, reference is made to the Downlink Reference Signals (DL-RS(s)) as reference signals transmitted from an apparatus being a base-station, reference device or positioning TRP/TP or the like. DL-RSs may be used to enable downlink positioning measurements for DL methods or UL and DL methods such as TDOA, RTT, multi-RTT or DL-AoD. DL-RS(s) may be referred to those skilled in the art as DL-PRS, LTE PRS, SL-PRS or any downlink or sidelink reference signal used for the purpose of positioning. Furthermore, other DL-RS (SSB, CSI-RS, etc.) may be also used as RS for positioning or related functions (synchronization, for example).

A RS may be a composite of several RS and is called (DL-)RS Resource Set in the 3GPP standard. The RS Resources in a DL-RS resource set may be associated with the same TRP or frequency layer. A DL-RS resource ID be assigned to each resource of a resource set. Each DL-PRS Resource ID in the DL PRS Resource Set may be associated with a specific spatial filter. A TRP may be configured with multiple DL-RS Resource Sets. A DL RS resource set consists of one or more DL RS resources and it is defined by multiple parameters. The Information Element Periodicity-and-ResourceSetSlotOffset-r16 defines the DL PRS resource periodicity per PRS Resource Set. All the DL-RS resources within one DL-RS resource set are configured with the same DL PRS resource periodicity. Where semi-persistent scheduling allocates DL resources with a certain period over a defined interval. For the case of aperiodic DL RS, a periodicity value is not configured.

A BS or a TRP may transmit multiple DL-RS resource sets, each containing multiple DL-RS resources. A DL-RS resource set may be a collection of beams (DL-RS resources) transmitted with a configured periodicity in configured offsets. Some sets may be configured with given periodicity. Since each DL-RS resource set is associated with a periodicity, each instance may span a continuous set slots. Each PRS resource of a DL-RS resource set may have a configured offset with respect to the SFN=0.

A DL-RS positioning frequency layer is defined as a collection of DL-RS resource sets that have common parameters configured by PositioningFrequencyLayer.

The DL-RS resources and resource set configurations are provided to the target UE on a higher layer interface such as LPP from the LMF or possibly from a serving cell over an RRC or MAC-CE or DCI interface. The target UE performs the measurements on the configured DL-RS resources.

The UE or a reference device may be configured for measurements on one or more DL-PRS or SL-PRS resources. The configuration may be provided to the UE with a high layer configuration message which includes assistance information on the DL-RS(s) resources transmitted from one or more BS or TRP. The assistance information for the DL-RS(s) may include one or more of the following information ResourceSet, ResourceSetId, Periodicity, ResourceRepetitionFactor, ResourceTimeGap, SFNO-Offset, ResourceSetSlotOffset, Resource, ResourceId, SequenceId, CombSizeN, ReOffset, ResourceSlotOffset, ResourceSymbolOffset, NumSymbols, QCL-Info, SubcarrierSpacing, CyclicPrefix, ResourceBandwidth, StartPRBDL-RS-PointA, RstdReferenceInfo, RstdMeasurementInfoRequest, UE-Rx-Tx-MeasurementInfoRequest, expected RSTD, RSTD-uncertainty, MutingPattern.

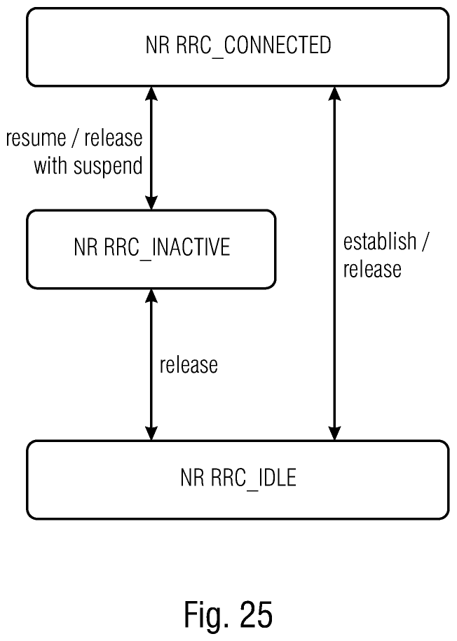

In the embodiments described herein, reference is made the UE that may be in three states in the NR: RRC_CONNECTED, RRC_INACTIVE and RRC_IDLE. FIG. 25 illustrates the mentioned states and the transitions from one state to another state.

### RRC_IDLE

In the RRC Idle state, the UE among other tasks does the following monitors a paging channel for CN paging using 5G-S-TMSI, performs neighboring cell measurements and cell (re-)selection based on network configuration and acquires system information and may send SI request, if configured to do so. Further, a reduced signaling and data connection compared to the RRC_CONNECTED may be supported in RRC_INACTIVE mode.

### RRC_INACTIVE

In RRC_INACTIVE, the UE among other tasks does the following monitors a Paging channel for CN paging using 5G-S-TMSI and RAN paging using full-RNTI, performs neighboring cell measurements and cell (re-)selection; performs RAN-based notification area updates periodically and when moving outside the configured RAN-based notification area; acquires system information and may send SI request (if configured).

### RRC_CONNECTED

In RRC_CONNECTED, the UE is able to transmit unicast data to and from UE. Furthermore, it monitors Short Messages transmitted with P-RNTI over DCI (see clause 6.5), if configured. It further monitors control channels associated with the shared data channel to determine if data is scheduled for it, provides channel quality and feedback information, Performs neighboring cell measurements and measurement reporting and acquires system information.

In accordance with embodiments described above, the assistance data, e.g. the AD for RRC_IDLE and/or RRC_INACTIVE, were shared or provided via the Uu interface. However, the present invention is not limited to such a scenario, rather, in accordance with further embodiments, the assistance data, like the AD for RRC_IDLE and/or RRC_INACTIVE, may be shared between UEs using a sidelink, like the PC5 interface.

### Assistance Data Management

As described above, in accordance with embodiments of the present invention, the UE performs the positioning measurements in accordance with the assistance data, AD, or an AD instance applicable for the UE at a current location of the UE in the wireless communication network.

In accordance with further embodiments, some or all of the AD may not be used any more or may need to be modified at the UE's current location. This may happen for a wide variety of reason, including but not limited to a change in the configuration of reference signals to accommodate the UEs served by the TRPs, a change in traffic demands, load balancing, energy saving. In such situations, the network may signal the UE to release part or all of the AD stored in the network for the current location. This signal may be conveyed using LPP signaling in any one of the RRC states.

For example, responsive to receiving certain information from the network, the UE may release some or all stored AD that is associated with the certain information. The certain information may be provided by indicating any one or more of the following:
a cell ID,
a PRS-ID,
a resource set ID,
a resource ID,
an AD indicator ID,
an area ID.

In accordance with embodiments, the UE may release some or all of the stored data for a certain cell, a certain area, a certain resource set ID or a certain resource.

If the release is applied to certain area, then all information of TRPs within the said area are to be removed from the AD corresponding to the said area. If the area is indicated using an AD instance, then all the information provided within this instance are released.

If the release is applied to a certain cell/TRP, then all information of TRPs within the said area are to be removed from the AD corresponding to the said area.

If the release is applied to certain resource set, then all information of TRPs within the said area are to be removed from the AD corresponding to the said area.

If the release is applied to certain resource, then all information of TRPs within the said area are to be removed from the AD corresponding to the said area.

In accordance with further embodiments, the AD may be modified by the network. The network may provide a new configuration of AD, which may include one or more new or additional resources, which may be appended to AD for an existing area, or an existing cell/TRP, or an existing resource set ID. In accordance with other embodiments, rather than appending the new resource to an existing AD, a present or existing resource in the AD may be indicated to be replaced or overwritten by the new resource. For example, this may include initially removing the present resource from the AD and then the new resource in the AD at the hierarchy as indicated.

### Handling of Changing Configuration

In accordance with embodiments, there may be devices in the network that are in a non-active state for most of the time and wake up only infrequently. For example, UEs with power consumption and data transfer rate limitations wake up infrequently. If the configuration in the network changes, such a UE needs to be notified ahead of time.

In accordance with embodiments, such a UE may be configured with two or more AD instances. For example, the UE, like a UE with a low power consumption, i.e. a longer battery life, may be pre-programmed with the AD instances. In accordance with embodiments, the AD instance may be provided offline, for example, before deployment of the UE or during a firmware update, and the AD instance may be referred to using AD instance identifier.

In accordance with embodiments, one AD instance may be valid until a certain time, and another AD instance may be valid after a given time, for a given area. In such a scenario, the network is expected to provide the DL-PRS signals corresponding to the first AD instance at least until the expiration time of the first AD and/or the network is expected to provide the DL-PRS signals corresponding to second AD instance latest when the first instance expires and/or the second instance begins its validity time. The validity time may be one of the following:
an expiration time indicating a time from which a certain AD is no longer valid,
a beginning of validity time indicating a time duration or interval for which a certain AD is longer valid,
a beginning time and an expiration time indicating the time from which a certain AD is longer valid and the time after which the certain AD is no longer valid.

In accordance with other embodiments, the network may signal to the UE which AD instance version is to be used, e.g., by simply signaling the AD identifier to enable the UE to use a certain AD instance. The network may also signal the AD identifier and/or AreaID to remove/update a certain portion of AD, e.g., in a way as described above regarding the handling of the AD.

In accordance with yet further embodiments, such a UE may be configured with only one AD instance and, if the AD changes, the UE is signaled to update the AD ahead of the time of the actual change of the AD, e.g., in a way as described above regarding the handling of the AD.

Although the respective aspects and embodiments of the inventive approach have been described separately, it is noted that each of the aspects/embodiments may be implemented independent from the other, or some or all of the aspects/embodiments may be combined. Moreover, the subsequently described embodiments may be used for each of the aspects/embodiments described so far.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

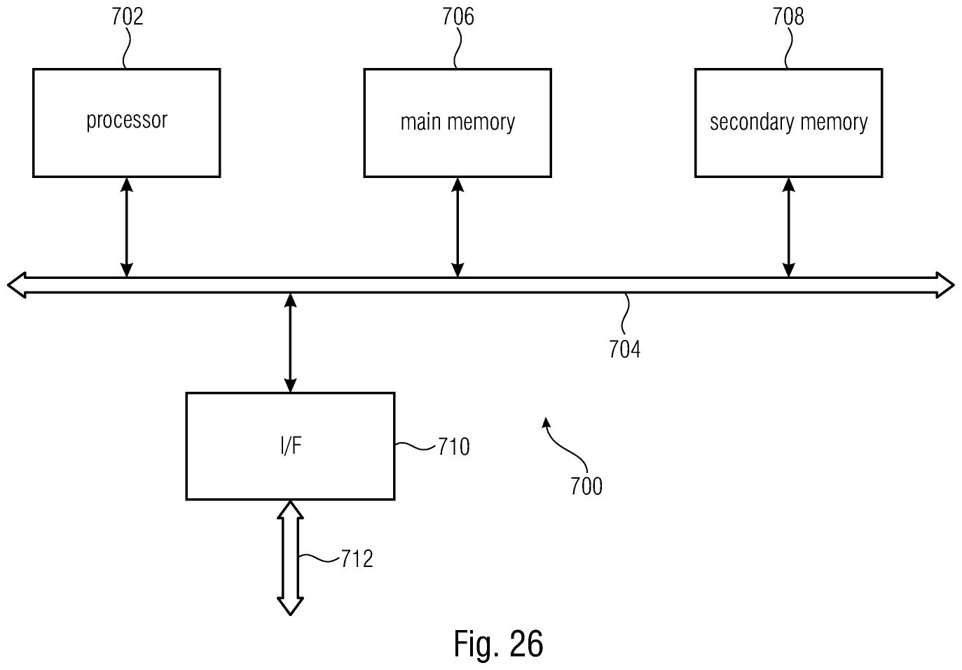

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 26 illustrates an example of a computer system 700. The units or modules as well as the steps of the methods performed by these units may execute on one or more computer systems 700. The computer system 700 includes one or more processors 702, like a special purpose or a general-purpose digital signal processor. The processor 702 is connected to a communication infrastructure 704, like a bus or a network. The computer system 700 includes a main memory 706, e.g., a random-access memory, RAM, and a secondary memory 708, e.g., a hard disk drive and/or a removable storage drive. The secondary memory 708 may allow computer programs or other instructions to be loaded into the computer system 700. The computer system 700 may further include a communications interface 710 to allow software and data to be transferred between computer system 700 and external devices. The communication may be in the from electronic, electromagnetic, optical, or other signals capable of being handled by a communications interface. The communication may use a wire or a cable, fiber optics, a phone line, a cellular phone link, an RF link and other communications channels 712.

The terms “computer program medium” and “computer readable medium” are used to generally refer to tangible storage media such as removable storage units or a hard disk installed in a hard disk drive. These computer program products are means for providing software to the computer system 700. The computer programs, also referred to as computer control logic, are stored in main memory 706 and/or secondary memory 708. Computer programs may also be received via the communications interface 710. The computer program, when executed, enables the computer system 700 to implement the present invention. In particular, the computer program, when executed, enables processor 702 to implement the processes of the present invention, such as any of the methods described herein. Accordingly, such a computer program may represent a controller of the computer system 700. Where the disclosure is implemented using software, the software may be stored in a computer program product and loaded into computer system 700 using a removable storage drive, an interface, like communications interface 710.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, of a wireless communication network,
wherein, for determining a position of the UE in accordance with a positioning procedure, the UE is to perform positioning measurements,
wherein the UE comprises an assistance data, AD, set, the AD set comprising a plurality of assistance data, AD, instances, each AD instance applicable for the UE to perform the positioning measurements at a certain location in the wireless communication network,
wherein the UE is to perform the positioning measurements in accordance with the AD instance activated by the UE for a current location of the UE in the wireless communication network,
wherein an area of the wireless communication network where an AD instance is applicable is indicated by an AD area identifier, and wherein the UE is to activate an AD instance from the AD set that comprises an AD area identifier that matches an area identifier for the current location of the UE, and
wherein the area identifier identifies a certain part or sub-area of the wireless communication network.

2. The user device, UE, of claim 1, wherein, for acquiring the AD set, the UE is to
receive the AD set form the wireless communication network, e.g., from the LMF, and/or
collect the AD instances while moving around in the wireless communication network.

3. The user device, UE, of claim 1, wherein, for collecting the AD instances, when moving from a current location to a new location in the wireless communication network and receiving for the new location a new AD instance, the UE is to maintain or store the new AD instance together with one or more existing AD instances applicable for other locations.

4. The user device, UE, of claim 2, wherein the UE is to receive the AD set or is to start to collect the AD instances
when entering a non-connected state, like an RRC_INACTIVE state or an RRC_IDLE state, or
when connecting to the network, e.g., when entering a connected state, like an RRC_CONNECTED state, or
when the UE is connected to the network, e.g. when there is a signaling connection according to a certain positioning protocol, like the LTE Positioning Protocol, LPP, between an element of the network, like the LMF, and the UE.

5. The user device, UE, of claim 1, wherein the UE is to acquire the area identifier corresponding to the current location of the UE by one or more of the following:
a signaling, like a unicast message,
a system information,
a measurement the UE performs on certain reference signals.

6. The user device, UE, of claim 1, wherein an AD instance is associated with one or more validity states, the one or more validity states comprising one or more of the following:
a spatial validity for indicating whether an applicability area with which the AD instance is associated matches a current area or location where the UE is located, and
a temporal validity for indication whether a time since providing the AD instance to the UE is within a predefined time period before the AD expires.

7. The user device, UE, of claim 6, wherein the applicability area comprises one or more of the following:
RAN notification area and/or a Tracking area,
a system information area,
a positioning system information area,
a cell,
a certain portion of a cell, or a certain portion of the RAN notification area or a certain portion of the system information area or a certain portion of the positioning system information area, denoted, e.g., by an area identifier,
a combination of portions of one or more cells, which may be denoted by an area identifier,
a combination of one or more of the above.

8. The user device, UE, of claim 1, wherein
an AD instance is assigned at least one of the following validity states: ACTIVE, DEACTIVATED, EXPIRED, INVALID, and
wherein
an AD instance is assigned an active state in case
the area identifier computed by the UE or provided to the UE by the wireless communication network matches the applicability area for the AD instance, and
a time elapsed since acquiring the AD instance is within the predefined time period,
an AD instance is assigned a deactivated state incase
the area identifier computed by the UE or provided to the UE by the wireless communication network does not match the applicability area for the assistance data, while a time elapsed since acquiring the AD instance is within the predefined time period,
an AD instance is assigned an expired state in case
a time elapsed since acquiring the AD instance exceeds the predefined time period, wherein the UE may store the AD instance so as to allow the expired AD instance to be refreshed responsive to a signaling of a continued validity of the AD instance, causing the expired AD instance to be moved either to a deactivated state or to an active state,
an AD instance is assigned an invalid state in case
a time elapsed since acquiring the AD instance exceeds the predefined time either the validity time is exceeded and the AD is not refreshed, or the wireless communication network signals configuration change to the UE, wherein the UE may delete the invalid AD instance.

9. The user device, UE, of claim 8, wherein, for indicating, e.g., to the LMF, capabilities of the UE with regard to the handling of the AD instances, the UE is to signal
the validity states supported by the UE, e.g., the UE may signal that it only stores an active AD instance, or an active AD instance and a deactivated AD instance, or an expired AD instance, and/or
that AD instances not corresponding to a current applicability area are stored, and/or
a number of expired AD instances the UE stores, and/or
a time period during which the UE stores expired AD instances.

10. The user device, UE, of claim 9, wherein, to signal that AD instances not corresponding to a current applicability area are stored, the UE is to
set a flag a certain value, thereby indicating that the UE stores AD corresponding to an area outside the current applicability area or
directly indicate the areas which the UE may store AD, e.g., by indication a number of PRS-ID+cell ID combinations for which the UE may store AD using the UE capability signaling.

11. The user device, UE, of claim 1, wherein the UE is to select an AD instance from the AD set
responsive to a signaling, e.g., by the LMF, of the selection of the AD instance, and/or
by associating measurements by the UE and/or a certain part of system information acquired by the UE with an AD instance.

12. The user device, UE, of claim 11, wherein the UE is to receive a signaling to select a certain one of the AD instances from the AD set as an active AD instance, wherein the signaling may optionally indicate an applicability of the active AD instance to different connection states, likes RRC states, and positioning modes, like a UE-assisted mode or a UE-based mode.

13. The user device, UE, of claim 11, wherein the signaling is
transmitted as a part of positioning system information or
is received by the UE in a unicast mode,
is relayed to the UE via other components of the wireless communication network.

14. The user device, UE, of claim 11, wherein the UE is to be provided with a configuration that maps measurements of the UE and/or a certain part of the system information acquired by the UE to a one or more AD instances from the AD set.

15. The user device, UE, of claim 12, wherein the UE is to
acquire the area identifier of the area where it is located, e.g., by
reading the system information, or
determining the cell where the UE is camped, e.g., by using cell-reselections measurements or an New Radio, NR, Cell Global Identifier, or
measurements on certain downlink reference signals, DL-RS, and
compare the area indicated by the AD area identifier and the area indicated by the area identifier of the UE location, so as to determine whether the AD instance is to be marked an active AD instance or not.

16. The user device, UE, of claim 1, wherein the AD set is configured with a predefined parameter, e.g., a ValidityScope and/or an ApplicabilityScope, the parameter indicating at least an area within a notification area where the AD set is applicable, and wherein the parameter may further indicate one or more of the following:
a states for the AD set, e.g., active, deactivated, expired or invalid,
whether the AD set is applicable to a certain positioning mode, like a UE-assisted mode, a UE-based mode, an RRC_INACTIVE mode, an RRC_CONNECTED mode, an RRC_IDLE mode or combinations thereof.

17. The user device, UE, of claim 16, wherein, in case the predefined parameter is not present, the UE is to assume the AD set to be applicable until a new AD set is provided for a UE.

18. The user device, UE, of claim 1, wherein the UE is to perform the positioning procedure in non-connected state, like an RRC_INACTIVE state or an RRC_IDLE stat, and responsive to a paging
the UE is to move to a connected state, like an RRC_CONNECTED state, and receive the AD set, and, after receiving the AD set, the UE is to return to the non-connected state, e.g., responsive to a suspend signaling, like an RRC_Suspend signal, and start or continue the positioning procedure in the non-connected state, or
the UE is to remain in the non-connected state and receive the AD set using a small data transmission, e.g., by using a MSG-B of a 2-step Random Access Preamble, RACH, procedure and/or using the regularly scheduled radio resources in the downlink, like semi-persistent or periodic scheduling of downlink resources applicable to RRC_INACTIVE or RRC_IDLE mode, for the UE or a group of UEs.

19. The user device, UE, of claim 18, wherein responsive to the paging the UE is to remain in the non-connected state and transmit the positioning measurements to the location server using a small data transmission, e.g., by using a MSG-A of a 2-step Random Access Preamble, RACH, procedure and/or using the regularly scheduled radio resources in the downlink, like semi-persistent or periodic scheduling of uplink resources applicable to RRC_INACTIVE or RRC_IDLE mode, for the UE or a group of UEs.

20. The user device, UE, of claim 1,
wherein the UE is to perform the positioning measurements in a connected state, like an RRC_CONNECTED state, and in accordance with the AD instance activated for the current location of the UE in the wireless communication network, and
wherein, responsive to changing from the connected state to a non-connected state, like an RRC_INACTIVE state or an RRC_IDLE state, the UE is to continue using the activated AD instance as long as one or more predefined criteria are met.

21. The user device, UE, of claim 20, wherein, responsive to changing from the connected state to a non-connected state, like the RRC_INACTIVE state or the RRC_IDLE state, and subsequently back to the connected state, like the RRC_CONNECTED state, the UE is to continue using the activated AD instance as long as one or more predefined criteria are met.

22. The user device, UE, of claim 20, wherein the one or more predefined criteria comprise one or more of the following:
the UE remains at the current location in the wireless communication network,
the UE is at a certain location in the wireless communication network for which the AD is valid,
an expiration time associated with the AD has not lapsed.

23. The user device, UE, of claim 1, wherein an AD instance for a certain location is extended so as to cover an area that is larger than the certain area.

24. The user device, UE, of claim 25, wherein, the UE is to apply at least one of the AD information of the extended AD in the non-connected state on one or more of the measurements.

25. The user device, UE, of claim 1, wherein
when the positioning procedure operates in an UE-Assisted mode, a location server knows the location of the UE, e.g., from a last reporting period, and the location server determines whether any AD component previously provided to the UE needs to be updated, wherein the location server may send the AD via a RAN entity, like a gNB hosting a cell, using a certain protocol, e.g., in a NR Positioning Protocol-Annex, NRPPa, message in case the AD is broadcast, or in a LTE Positioning Protocol, LPP, message in case the AD is unicast via the gNB to the UE,
from where the UE last sent measurements either in connected state or in non-connected state, or
where the UE initiated an RAN-based Notification Area, RNA, update procedure, and
when the positioning procedure operates in an UE-Based mode, the UE is to send an AD request to the location server if the UE determines that AD provided in unicast mode are not suitable for determining the position, wherein the UE may optionally send the area identifier where the UE is currently located, so that the location server may provide updated assistance data to the UE.

26. The user device, UE, of claim 1, wherein, when the UE moves outside the notification area, the UE is to
discard all AD held by the UE,
initiate an RNA update or a Tracking Area Code, TAC, update,
acquire a new positioning configuration
from a broadcast by a camped cell ,or
by sending a request for AD, the request indicating the new RNA or TAC area.

27. The user device, UE, of claim 1, wherein the UE is to receive the AD or AD instance or an update of the AD or AD instance in a Positioning System Information Block, posSIB, the posSIB comprising the AD or AD instance, and, optionally, AD information, like validity area, indicated by area indicator and validity time, and AD version.

28. The user device, UE, of claim 1, wherein the AD for the positioning procedure comprises one or more of the following AD parameters:
a number of frequency layers,
a number of Transmission Reception Points, TRPs, per frequency layer,
a number of resource set per TRP,
a number of resources per resource set,
an area and/or a duration where the AD is to be considered valid,
a priority of the order in which reference signal resources for the positioning procedure, like the downlink positioning reference signal, DL-PRS, are to be processed,
a delivery or transmit mechanism for the AD.

29. The user device, UE, of claim 1, wherein an AD or an AD instance for the positioning procedure to be performed by the UE in the connected state, like an RRC_CONNECTED state, differs in at least one or more AD components from an AD or an AD instance for the positioning procedure to be performed by the UE in the non-connected state, like an RRC_INACTIVE state or an RRC_IDLE state,

30. The user device, UE, of claim 1, wherein at least one or more AD components of an AD or an AD instance differ in their validity and/or applicability, e.g., some AD components may be valid for wider area than other AD components, or may be applicable to more UEs than other AD components

31. The user device, UE, of claim 1, wherein the AD or the AD instance comprises one or more of the following AD components:
an AD component regarding a configuration of DL reference signals,
an AD component for selecting a subset of DL-PRS signals for measurements corresponding to one or more positioning methods,
an AD component regarding the priority of the order in which the DL-PRS signals are to be measured,
an AD component for determining a validity information of the AD,
an AD component regarding an applicability of the AD.

32. The user device, UE, of claim 31, wherein the AD component regarding a configuration of DL reference signals for the positioning procedure to be performed by the UE in the non-connected state accommodates a number of TRPs that is larger than a number of TRPs in an AD component regarding a configuration of DL reference signals for the positioning procedure to be performed by the UE in the connected state.

33. The user device, UE, of claim 29, wherein, for AD components for the positioning procedure to be performed by the UE in the non-connected state,
the UE is to receive an AD component for selecting a subset of DL-PRS signals for measurements corresponding to one or more positioning methods each time the wireless communication network, like the LMF, determines that different resources are to be selected by the UE for a given positioning method, or
the UE is preconfigured with several sets of AD components for selecting a subset of DL-PRS signals for measurements corresponding to one or more positioning methods, and the UE is to select the DL-PRS the UE needs to measure during the non-connected state for every method, e.g., responsive to a signaling from the wireless communication network, like the LM.

34. The user device, UE, of claim 31, wherein the AD component regarding the priority of the order in which the DL-PRS signals are to be measured comprises:
a priority list referring to resources in the AD component regarding a configuration of DL reference signals and/or the AD component for selecting a subset of DL-PRS signals for measurements corresponding to one or more positioning methods, or
information for determining the priority list using a measurement on downlink reference signals, like a Synchronization Signal Block, SSB, the UE is configured with for measurement for the mobility management.

35. The user device, UE, of claim 1, wherein
the UE is to receive one or more AD components of the AD or AD instance in accordance with one or more of the following:
in a single message or distributed between one or more messages,
in a unicast message,
in a multicast message,
in a groupcast message,
in a broadcast message,
in a combination of any one of a unicast message and/or a broadcast message and/or a message groupcast and/or a multicast message, and
the UE, after receiving the AD components of the Ad, is to combine the received AD components to form the AD or AD instance.

36. The user device, UE, of claim 35, wherein
in case the UE receives same AD component by more than one of the unicast message, the multicast message, the groupcast message, and the broadcast message, the UE is to use the AD component received by a messages associated with a highest priority, wherein the unicast message comprises a priority higher than the multicast message, the multicast message comprises a priority higher than the groupcast message, and the groupcast message comprises a priority higher than the broadcast message, and/or wherein the priorities of different messages may be specified according to some fixed rules and/or may be signaled to the UE,
in case same AD components are missing in the broadcast message, but are provided by one or more of the unicast message or the multicast message or the groupcast message, the UE is to combine the AD components from the broadcast message and the unicast or multicast or groupcast message.

37. The user device, UE, of claim 35, wherein
responsive to receiving a new broadcast message comprising one or more AD components that is changed when compared to a previous broadcast message, in case an AD component provided via a previous unicast message has not associated any expiration time, the UE is to employ the AD component from the unicast message used together with AD components from a previous broadcast message together with the AD components from the new broadcast message, and/or
in case a combination of AD components of two or more of the unicast or multicast or groupcast or broadcast messages cause an inconsistent AD configuration, the UE is to drop the acquired AD or AD instance and is to use a previous AD of AD instance.

38. The user device, UE, of claim 35, wherein
the UE is configured with one or more AD components by one or more of the multicast message, the groupcast message and the broadcast message, and
responsive to receiving an AD component via a unicast message, the UE is to overwrite the corresponding AD component received by one or more of the multicast message, the groupcast message and the broadcast message, or
responsive to determining an AD component to be not needed, the UE is to omit the corresponding AD component received by one or more of the multicast message, the groupcast message and the broadcast message.

39. The user device, UE, of claim 1, wherein an AD or an AD instance is applicable for the UE at the current location of the UE and for the current time.

40. The user device, UE, of claim 1, wherein the UE is to signal its capability to perform the positioning procedure in a non-connected mode.

41. The user device, UE, of claim 1, wherein
the UE is in a Registration Management registered, RM-REGISTERED, mode, wherein the UE is to be paged by the wireless communication network either via core-network paging or via RAN-paging,
a location server, e.g. an LMF, comprises at least one positioning session, like a LPP session, for a UE, in response to a mobile originated, MO, network initiated, NI, mobile terminated, MT, a deferred mobile originated, D-MO, or a deferred mobile terminated, D-MT, positioning session, and
the location server is to communicate with any NG-RAN node, such as a gNB, a ng-eNodeB, a TRP, a TP, a RP, which is reachable via the Access and Mobility Function, AMF, with signaling access to both location server and the NG-RAN node.

42. The user device, UE, of claim 1, wherein the positioning procedure operates in accordance with one or more of the following positioning methods:
angle of arrival, AoA,
angle of departure, AoD,
time of arrival, ToA,
time of flight, ToF,
time difference of arrival, TDOA, like OTDOA and UL-TDOA
enhanced Cell ID,
NR-Multi-RTT.

43. The user device, UE, of claim 1, wherein, responsive to a signaling from the network, the UE is to release and/or modify some or all of the AD.

44. The user device, UE, of claim 1, wherein the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

45. A Location Management Function, LMF, apparatus for determining a position of a user device, UE, of a wireless communication network, which is in a non-connected state, like an RRC_INACTIVE state or an RRC_IDLE state, the apparatus comprising:
a position determining processor to determine a position of the UE, responsive to receiving from the UE positioning measurements,
wherein the apparatus is to provide the UE with an assistance data, AD, set, the AD set comprising a plurality of AD instances, each AD instance applicable for the UE to perform positioning measurements in the non-connected state at a certain location in the wireless communication network, thereby allowing the UE to activate, responsive to determining a current location of the UE in the wireless communication network, an AD instance from the AD set that corresponds to or is associated with the current location of the UE,
wherein an area of the wireless communication network where an AD instance is applicable is indicated by an AD area identifier, and wherein the UE is to activate an AD instance from the AD set that comprises an AD area identifier that matches an area identifier for the current location of the UE, and
wherein the area identifier identifies a certain part or sub-area of the wireless communication network, and
wherein the apparatus is to provide the UE with the AD set during a paging occasion for the UE.

46. The apparatus of claim 45, wherein the apparatus is to provide the AD set in a broadcast mode, e.g., in case of a change of system information, or in a unicast mode, e.g., in case of detecting a movement of the UE form a current location to a new location in the wireless communication network, or responsive to a request from the UE.

47. The apparatus of claim 45, wherein the apparatus is provided in a core network, CN, entity of the CN of the wireless communication network, or in a radio access network, RAN, entity of the RAN of the wireless communication network.

48. A wireless communication system, comprising one or more user devices, UEs, of claim 1 and/or a Location Management Function, LMF, apparatus for determining a position of a user device, UE, of a wireless communication network, which is in a non-connected state, like an RRC_INACTIVE state or an RRC_IDLE state, the LMF apparatus comprising:
a position determining processor to determine a position of the UE, responsive to receiving from the UE positioning measurements,
wherein the apparatus is to provide the UE with an assistance data, AD, set, the AD set comprising a plurality of AD instances, each AD instance applicable for the UE to perform positioning measurements in the non-connected state at a certain location in the wireless communication network, thereby allowing the UE to activate, responsive to determining a current location of the UE in the wireless communication network, an AD instance from the AD set that corresponds to or is associated with the current location of the UE,
wherein an area of the wireless communication network where an AD instance is applicable is indicated by an AD area identifier, and wherein the UE is to activate an AD instance from the AD set that comprises an AD area identifier that matches an area identifier for the current location of the UE, and
wherein the area identifier identifies a certain part or sub-area of the wireless communication network, and
wherein the apparatus is to provide the UE with the AD set during a paging occasion for the UE.

49. The wireless communication system of claim 48, further comprising one or more RANs and a CN, wherein the location server is part of the RAN or of the CN, and wherein a RAN entity comprises one or more of the following: a macro cell base station, or a small cell base station, or a central unit of a base station, or a distributed unit of a base station, or a road side unit (RSU), or a UE, or a group leader (GL), or a relay or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

50. A method for operating a user device, UE, of a wireless communication network, the method comprising:
performing, by the UE, positioning measurements to be used for determining a position of the UE in accordance with a positioning procedure, wherein the UE comprises an assistance data, AD, set, the AD set comprising a plurality of assistance data, AD, instances, each AD instance applicable for the UE to perform the positioning measurements at a certain location in the wireless communication network,
wherein the UE performs the positioning measurements in accordance with the AD instance activated by the UE for a current location of the UE in the wireless communication network,
wherein an area of the wireless communication network where an AD instance is applicable is indicated by an AD area identifier, and wherein the UE activates an AD instance from the AD set that comprises an AD area identifier that matches an area identifier for the current location of the UE, and
wherein the area identifier identifies a certain part or sub-area of the wireless communication network.

51. The method of claim 50,
wherein the UE performs the positioning measurements in a connected state, like an RRC_CONNECTED state, and in accordance with the AD instance activated by the UE for the current location of the UE in the wireless communication network, and
wherein, responsive to changing from the connected state to a non-connected state, like an RRC_INACTIVE state or an RRC_IDLE state, continuing using the activated AD instance as long as one or more predefined criteria are met.

52. The method of claim 50, wherein the AD is extended so as to cover an area that is larger than the certain area.

53. A non-transitory digital storage medium having a computer program stored thereon to perform the method for operating a user device, UE, of a wireless communication network, the method comprising:
performing, by the UE, positioning measurements to be used for determining a position of the UE in accordance with a positioning procedure, wherein the UE comprises an assistance data, AD, set, the AD set comprising a plurality of assistance data, AD, instances, each AD instance applicable for the UE to perform the positioning measurements at a certain location in the wireless communication network,
wherein the UE performs the positioning measurements in accordance with the AD instance activated by the UE for a current location of the UE in the wireless communication network,
wherein an area of the wireless communication network where an AD instance is applicable is indicated by an AD area identifier, and wherein the UE activates an AD instance from the AD set that comprises an AD area identifier that matches an area identifier for the current location of the UE, and
wherein the area identifier identifies a certain part or sub-area of the wireless communication network,
when said computer program is run by a computer.
